(19) United States
(12) Patent Application Publication
(10) Pub. No.: US 2026/0167220 A1
(43) Pub. Date: Jun. 18, 2026

(54) TRAFFIC FLOW VECTOR FIELDS

(71) Applicant: Zoox, Inc., Foster City, CA (US)

(72) Inventors: Rasmus FONSECA, Boulder Creek, CA (US); Genie KIM, San Francisco, CA (US); Yangwei LIU, Newark, CA (US); Arunabh MISHRA, Brookline, MA (US); Glen Thomas NEVILLE, Medford, MA (US); Willem PRINS, San Francisco, CA (US); Oytun ULUTAN, Buena Park, CA (US)

(21) Appl. No.: 18/986,582

(22) Filed: Dec. 18, 2024

(51) Int. Cl. B60W 60/00; G01C 21/34; G05B 13/02; G06T 7/20

(52) U.S. Cl. CPC B60W 60/001; G01C 21/3492; G05B 13/027; G06T 7/20; B60W 2520/10; B60W 2554/4042; B60W 2720/10; G06T 2207/20081; G06T 2207/30256

(57) ABSTRACT

Techniques described herein involve a determination of a set of vectors associated with a vector field that is indicative of a traffic direction in the environment. Data associated with an environment in a vicinity of a vehicle is received. Based on the data, a set of vectors associated with a vector field that is indicative of a traffic direction in the environment is determined. The vectors in the set of vectors are indicative of the traffic direction at respective positions in the environment. Instructions are generated to control the vehicle based at least in part on the set of vectors.

### BACKGROUND

Vehicle control systems commonly implement decision-making processes based on environmental inputs. The decision-making processes are typically based on predefined rules, resulting in rigid control instructions for a vehicle. This approach to planning can create challenges in representing real-world scenarios that occur in traffic environments. For instance, conditions not captured in the rule-based decision-making process may lead to unexpected behavior. The nature of these decisions can affect vehicle performance.

### BRIEF DESCRIPTION OF DRAWINGS

The detailed description is described with reference to the accompanying figures. The use of the same reference numbers in different figures indicates similar or identical components or features.

FIG. 1 is a schematic diagram showing a vehicle operating within an example environment;

FIG. 2 is a flowchart and schematic diagrams showing an example method performed by a computing system associated with a vehicle;

FIG. 3 is a flowchart showing an example method for training a machine learning model;

FIG. 4 is a flowchart showing a general process for determining vectors associated with traffic flow;

FIG. 5 is a flowchart showing an example method for determining vectors associated with traffic flow using sensor data;

FIG. 6 is a flowchart showing a method for updating vectors associated with traffic flow;

FIG. 7 is a flowchart showing a method process for determining first and second sets of vectors associated with traffic flow;

FIG. 8 is a flowchart showing a method for training a machine learning model;

FIG. 9 is a flowchart showing a method for controlling a vehicle through an environment based on a determined set of vectors;

FIG. 10 is a flowchart showing a method for controlling a vehicle based on a determined set of vectors and sensor data;

FIG. 11A is a schematic diagram showing a vehicle operating within a further example environment;

FIG. 11B is a schematic diagram showing a vehicle operating within a further example environment;

FIG. 12 is a schematic diagram showing a vehicle operating within a further example environment;

FIG. 13 is a schematic diagram showing a vehicle operating within a further example environment;

FIG. 14 is a schematic diagram showing a vehicle operating within a further example environment; and

FIG. 15 is a block diagram of an example system for implementing the techniques described herein.

### DETAILED DESCRIPTION

A vehicle control system may determine a trajectory for a vehicle to follow. The trajectory may be based on a planned path of a vehicle through an environment and towards a desired destination. The planned path may take into account one or more environmental conditions, such as a road direction, traffic density, weather conditions amongst other example conditions.

Typically, a trajectory may also be based on transportation regulations such as speed limits, traffic signal rules, right-of-way, staying in a lane, and overtaking rules, to name just a few examples. While the planned path may therefore comply with relevant transportation regulations, strict adherence to the regulations means that the vehicle control system may find it difficult to determine a trajectory in certain rare and unusual transportation scenarios, or in situations where an unwritten rule is applied.

Consider an example where a vehicle comprising a vehicle control system is traversing a road. A construction worker is standing by the side of the road holding a stop sign. Other vehicles in a flow of traffic that includes the vehicle are not stopping at the stop sign, for example because the stop sign is not being directed at the flow of traffic, or because the construction worker is being held by the construction worker but not in use. Drivers of the other vehicles are aware that the stop sign does not need to be adhered to. However, the vehicle control system may identify the stop sign and generate a set of instructions to control the vehicle accordingly. The set of instructions may be associated with a trajectory that involves bringing the vehicle to a stop in accordance with the stop sign. The vehicle control system may do this because it has been trained to comply with a road rule that means that the vehicle must come to a stop when a stop sign is present.

Without further contextual information, the vehicle control system may be unable to determine a trajectory that does not adhere to the stop sign. This means that the vehicle may erroneously come to a stop in a moving flow of traffic, thereby potentially impacting other vehicles in the flow of traffic.

There may be other scenarios wherein such a vehicle control system may be unable to generate an appropriate set of control instructions for the vehicle due to adherence to transportation regulations or out of distribution and anomalous behaviour of other vehicles or objects in the environment. The present disclosure describes techniques that provide such vehicle control systems with additional contextual information in the form of vectors associated with a vector field that is indicative of at least a traffic direction in an environment. The vectors may also be indicative of a traffic speed in the environment. The vectors may provide a representation of traffic flow which may be at least partially used to generate instructions to control a vehicle.

For instance, in the above example, the vehicle control system may determine a set of vectors indicative of traffic direction and speed based on sensor data captured by one or more sensors associated with the vehicle. The vectors may indicate that the traffic speed is non-zero in the vicinity of the stop sign. The vectors may indicate that the traffic flow in the current scenario does not differ from a known traffic flow for this portion of road. The vectors may therefore provide the vehicle control system with additional information that may allow for a determination of a trajectory that does not involve bringing the vehicle to a stop in the vicinity of the stop sign.

This is a simple example scenario in which the vectors may be useful. It will become apparent in the following discussion that the techniques herein are applicable to other scenarios. For example, the described techniques may be applicable wherever traffic is, or is expected to be, present. Such example scenarios may include speed matching scenarios where a vehicle moves into a different lane where traffic in that lane is moving at a different speed from that of the vehicle, scenarios with unmarked roads making a determination of the lanes difficult based on sensor data alone, scenarios with unexpected lane closures resulting in unusual traffic flow through a portion of road, and scenarios involving gridlock. The techniques describe herein may also at least partially assist in anomaly detection, for example by comparing object behaviour to a set of vectors associated with a flow of that object, and identifying that the object behaviour is anomalous, or out of distribution, compared to what is expected based on the set of vectors. Example anomalies that may be detected in this manner include other vehicles behaving in an unexpected manner, such as performing a three-point turn unexpectedly, scenarios involving jaywalkers, scenarios involving slow-in-lane or speeding vehicles, amongst other examples.

In this way, the vectors indicative of traffic flow at various positions through the environment provide a further modality upon which a vehicle control system can base its decisions when determining trajectories for a vehicle.

While the techniques described herein are discussed primarily with respect to vehicles traversing roads, it is understood that the techniques may be applicable to other systems that are associated with traffic flow, such as pedestrians moving along footpaths, cyclists moving along roads and/or cycle paths, boats traversing waterways, and air traffic traversing flightpaths.

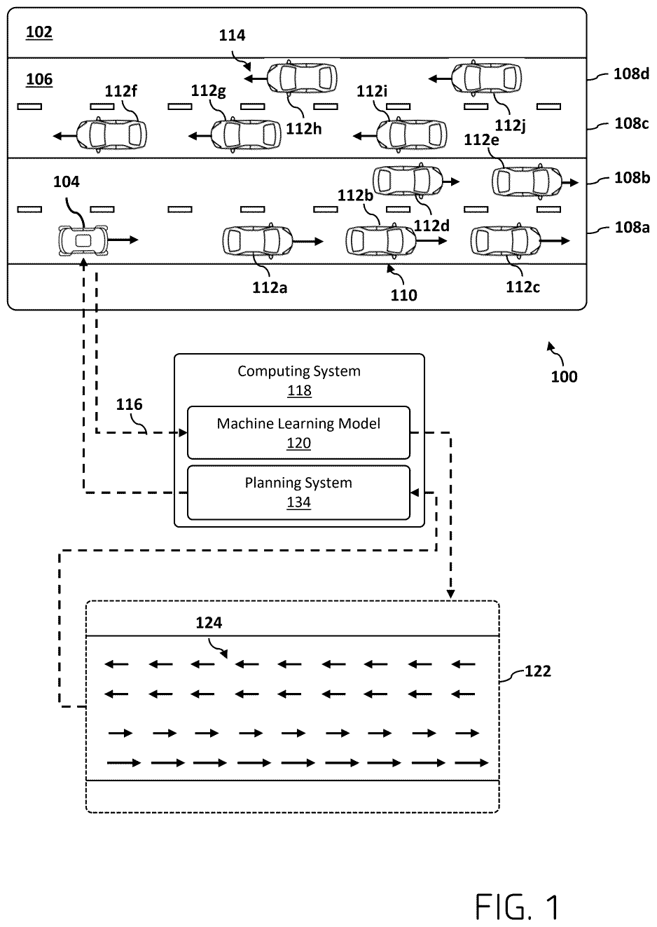

Various aspects of the techniques will now be described with regards to FIGS. 1 to 3. FIG. 1 illustrates an example scenario 100 comprising a vehicle 104 operating within an environment 102. The environment 102 includes a road 106 and a plurality of other vehicles 112a-j that, along with the vehicle 104, form traffic 110 traversing the road 106. While the vehicle 104 and other vehicles 112a-j are illustrated as moving along the road 106, in some examples the vehicle 104 and/or one or more of the other vehicles 112a-j may be stationary, such as when stopped at a stop sign, red light, or when parked in the environment 102. Some later described example scenarios involve the vehicle 104 and/or at least one other vehicle 112a-j being stationary.

In some examples, the vehicle 104 may be an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. In such an example, since the vehicle 104 may be configured to control all functions from start to stop, including all parking functions, it can be unoccupied. In some examples, the vehicle 104 may include a semi-autonomous vehicle configured to perform at least a portion of the control functions associated with vehicular operation.

The road 106 in the example scenario 100 comprises four lanes 108a-d, with two lanes 108a, 108b associated with a first direction of traffic and two lanes 108c, 108d associated with a second, opposite, direction of traffic. Vehicles 112a-e are shown travelling in the first direction of traffic, and vehicles 112f-j are shown travelling in the second direction of traffic. The traffic 110 in this example comprises vehicles in the form of cars, but it is understood that generally, the traffic 110 may comprise vehicles of any kind.

Traffic, as will be used herein, is generally understood to refer to a flow, or intended flow, of transport. This therefore includes one or more vehicles traversing a transportation network. Each of the one or more vehicles has a corresponding velocity representing an instantaneous speed of that vehicle and its instantaneous heading, direction or yaw. The velocity may be defined with respect to any frame of reference. The primary frame of reference used herein will be a frame associated with a transportation network (i.e. a frame in which the road 106 is stationary), but it is understood that other frames may be used, such as a frame associated with the vehicle 104 (i.e. where the vehicle is stationary). The velocity may be zero meaning that the associated vehicle is stationary, with respect to that frame of reference. With this in mind, in some examples, it is understood that the traffic may not be moving, such as in congested conditions or when stopped at a stop signal. Even when stationary however, the traffic will have an associated direction based on the intended flow of movement.

Some examples described herein involve scenarios involving no other vehicles, and so traffic is also understood to refer to an intended flow of vehicles. For example, the traffic flow that would be present if one or more vehicles were to be present.

In the example scenario 100, the traffic 110 has two, oppositely directed flows of vehicles. In other examples, traffic may have more or fewer than two flows of vehicles. Traffic flows may, in some examples, intersect such as at junctions and intersections.

A movement of the vehicles 104, 112a-j forming the traffic 110 is illustrated in FIG. 1 by vectors 114 attached to the front of the vehicles 104, 112a-j. Each vector 114 in this example has a magnitude indicative of a speed of the associated vehicle and a direction indicative of travel direction, yaw, or heading of the associated vehicle.

As illustrated, the vehicle 104 is in a first lane 108a having three other vehicles 112a-c. A second lane 108b has other vehicles 112d, 112e moving at a relatively lower speed than the other vehicles 112a-c in the first lane 108a, as indicated by shorter vector arrows 114. A third lane 108c and a fourth lane 108d have other vehicles 112f, 112g, 112i and other vehicles 112h, 112j respectively, travelling in an opposite direction from the vehicle 104.

The vehicle 104 uses the techniques described herein, namely the use of vectors indicative of traffic flow, to traverse the environment 102. Vectors indicative of traffic flow may be robust to unexpected behaviour from one or more vehicles and/or agents in the environment 102, allowing the vehicle 104 to make better decisions about how to traverse the environment 102. For example, the vehicle 104 may not rely solely on sensor data and/or map date to traverse the environment 102 since there may be unforeseen scenarios that cause the usual decision-making processes to produce unsatisfactory control instructions for the vehicle 104.

The vehicle 104 is associated with a computing system 118. The vehicle 104 may itself comprise the computing system 118, or the computing system 118 may be a remote computing system that is coupled to a computing system of the vehicle 104 via one or more communication networks. In the illustrative example of FIG. 1, the computing system 118 comprises a machine learning model 120 and a planning system 134. The machine learning model 120 is illustrated as being separate from the planning system 134, but it is understood that the planning system 134 may include the machine learning model 120 in some examples. In other examples, the machine learning model 120 may be located in a different system, perhaps on a different computing system, from the planning system 134. The computing system 118 may be considered to form at least part of a vehicle control system configured to control aspects of the vehicle 104.

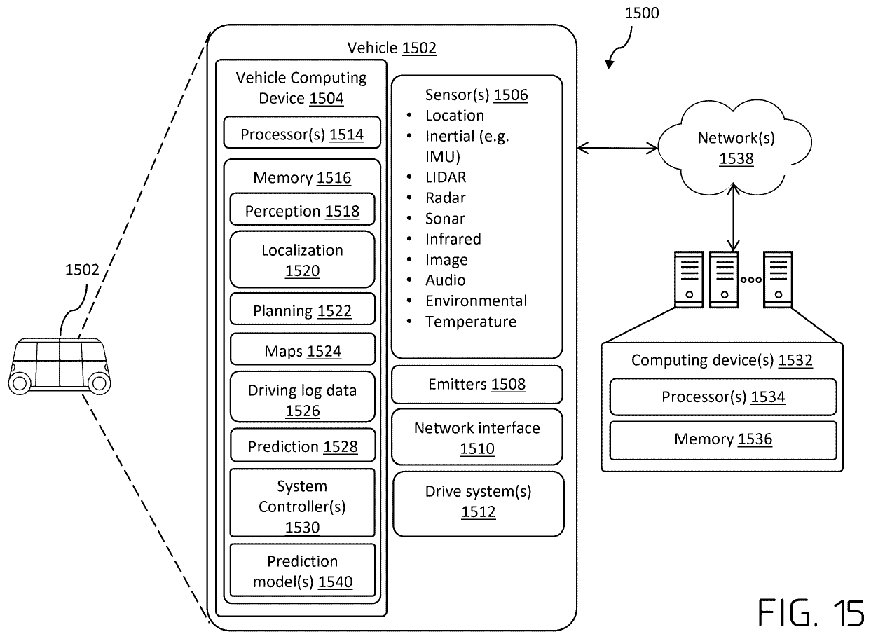

Data 116 indicating information about an environment in a vicinity of the vehicle 104 is provided to the machine learning model 120. In an example, the data may comprise, or be associated with, sensor data captured by sensors associated with the vehicle 104, thereby providing an indication of a current state of the environment 102. For instance, the sensor data may be an image captured by a camera coupled to the vehicle 102. Other example sensors include motion detectors, lidar, radar, inertial sensors, and the like. The sensors may be mounted on the vehicle 102 and/or may be remote from the vehicle 102, such as those mounted on other vehicles and/or mounted in the environment 102. Additional details associated with sensors are described below with regard to FIG. 15.

Where the data is sensor data, the sensor data may undergo pre-processing before being provided to the machine learning model 120. For instance, the sensor data may be processed to identify and classify at least one of the other vehicles 112a-j in the sensor data. Further, the data may be processed to determine current speeds and directions of the other vehicles 112a-j as well as trajectories for any other objects in the environment 102 that are captured in the sensor data. It is understood that, although not illustrated, any number and type of objects, including static objects, e.g., parked vehicles, buildings, or the like, and/or dynamic objects, e.g., pedestrians, animals, cyclists, trucks, motorcycles, other vehicles, or the like, can additionally or alternatively be present in the environment 102.

A computing system (for example the computing system 118) may determine object relevance and predicted object trajectories utilizing techniques such as those described in U.S. patent application Ser. No. 16/389,720, filed Apr. 19, 2019 and entitled “Dynamic Object Relevance Determination,” U.S. patent application Ser. No. 16/417,260, filed May 20, 2019 and entitled “Object Relevance Determination,” U.S. patent application Ser. No. 15/807,521, filed Nov. 8, 2017, and entitled “Probabilistic Heat Maps for Behavior Prediction,” U.S. patent application Ser. No. 16/151,607, filed Oct. 4, 2018 and entitled “Trajectory Prediction on Top-Down Scenes,” U.S. patent application Ser. No. 16/504, 147 filed Jul. 5, 2019 and entitled “Prediction on Top-Down Scenes based on Action Data,” the entire contents of each of which are incorporated herein by reference for all purposes.

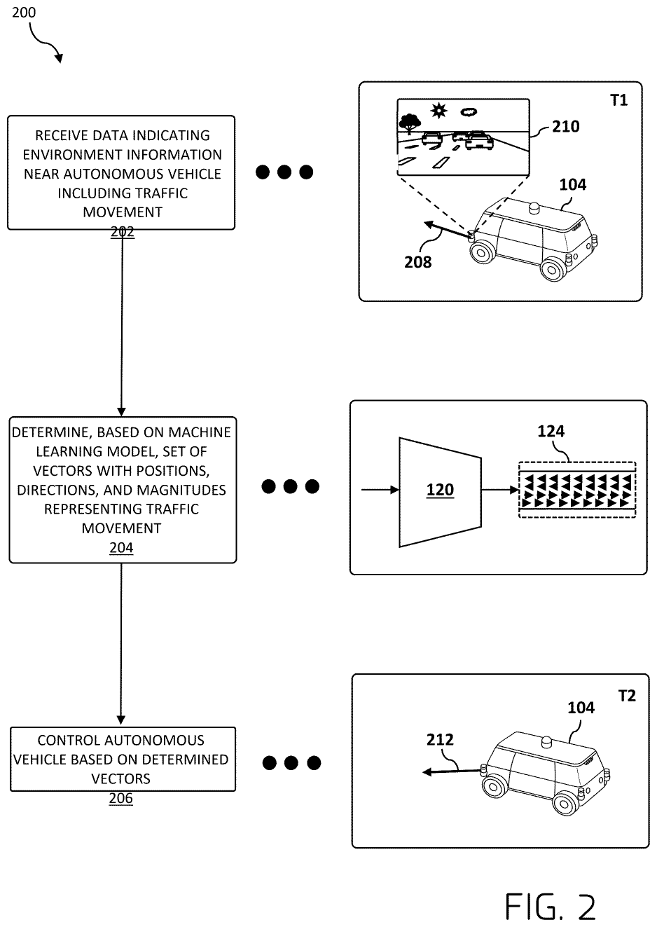

Preprocessing the sensor data may result in the generation of an abstract representation of the environment 102. The abstract representation may provide information of the environment 102 in a form suitable for provision to the machine learning model 120. In some examples, the data may be preprocessed to form a top-down representation of at least a portion of the environment 102. For example, a view associated with the sensor, such as the view 210 illustrated in FIG. 2, may be transformed, or mapped, to a top-down view such as that shown in FIG. 1.

The data 116 may also, or alternatively, comprise predetermined map data indicating information about an area in the vicinity of the vehicle 104 that includes a portion of the road 106. In an example, a geographic location of the vehicle 104 may be determined. Map data associated with the determined geographic location may be obtained, retrieved or determined. The map data may indicate one or more of a road layout, road geometry, traffic signal locations, speed limits, lane direction, road surface conditions, environmental features, and the like. Use of map data may provide an indication of the environment 102 at a point in time that the map data was generated.

The data 116 may also, or alternatively, comprise other environmental data such as information regarding current weather conditions. For instance, rain, snow, fog, and wind, are known to impact traffic flow. The data may comprise an indication of a time of day and/or day of the week. For instance, rush hour traffic may be associated with slower speeds than non-rush hour traffic.

In some examples, the data 116 provided to the machine learning model 120 may comprise a combination of different modalities of data. For instance, the data 116 may comprise a portion corresponding to sensor data generated by a sensor associated with the vehicle 104 and a portion corresponding to map data associated with a geographical location of the vehicle 104. In this way, information about current conditions in the environment 102 obtained from the sensor data may be combined with predetermined map data to provide a more complete picture of the environment 102.

The machine learning model 120 may be configured to process the data 116 to generate a set of vectors 122. Each vector 124 in the set of vectors 122 is associated with a respective position in the vicinity of the vehicle 104. In the example scenario 100, each vector 124 has a direction indicative of a direction of the movement of traffic 110 at the respective position and a magnitude indicative of a speed of the movement of traffic 110 at the respective position. In other examples, each vector may indicate one of the speed or direction at the respective positions.

The speed of the movement of traffic may be at least one of: a current speed of the traffic, and an intended speed of the traffic. The positions at which vectors 124 of the set of vectors 122 are computed does not need to align with positions in which other vehicles 112a-j or objects are located in the environment 102. Generally, the set of vectors 122 represent at least some indication of traffic flow at each position in which they are computed. In this way, the set of vectors 122 may represent a more detailed characterization of the traffic flow through the environment 102 than can be obtained from sensor data or map data alone. The use of a machine learning model 120 enables the set of vectors 122 to be determined for a scenario that has not been encountered before. The inventors have also found that a machine learning model 122 can determine an accurate set of vectors in a scenario where no vehicles are present and where vehicles in the environment are stationary.

The set of vectors 122 may form a discretized vector field, in the sense that there may be understood to be an underlying vector field where a vector is associated to every point in the environment 102. In that respect, the set of vectors 122 may represent a finite subset of such an underlying vector field. The direction and magnitude of each vector 124 may be a quantized representation of a vector of the underlying vector field. For example, each vector 124 may have a direction selected from one of a discrete number of directions and/or may have a magnitude selected from one of a discrete number of magnitudes. The resolution of the directions and/or magnitudes may be determined based on such factors as a desired accuracy level of the set of vectors 122, an available storage capacity and a compute resource availability.

The density of individual vectors 124 in the set of vectors 122 may be selected or determined based on a desired traffic flow resolution. For instance, a lower density of individual vectors 124 in the set of vectors 122 may enable more efficient processing of traffic flow data, while a higher density of individual vectors 124 in the set of vectors 122 may provide more nuanced and detailed characterization of the traffic flow in the environment 102. Extrapolation techniques may be used to increase the density of individual vectors 124 in the set of vectors 122. Any suitable extrapolation technique may be used to achieve this.

The spatial distribution of the vectors 124 within the set of vectors 122 may be selected or determined based on a desired distribution. In FIG. 1, the vectors 124 are distributed approximately evenly, or uniformly, throughout the environment 102. However, in other examples, the vectors 124 may be distributed unevenly, or non-uniformly. For instance, vectors 124 associated with positions behind the vehicle 104 may be less relevant to those associated with positions in front of the vehicle 104, and so it may be favorable to include vectors associated with positions in front of the vehicle 104. Vectors 124 associated with positions closer to the vehicle 104 may be favored compared to vectors associated with positions further from the vehicle. Vectors 124 may also be determined for locations outside of the road 106. This may enable the vehicle 104 to consider alternative routes in case of adverse safety scenarios, for example, the use of shoulders or off-road portions. Regions where no vectors are present are indicative of regions where no traffic flow is present or expected to be present.

In some examples, the vectors 124 may be distributed evenly within at least a portion of the environment 102. In this way, each vector 124 in the set of vectors 122 may be associated with a corresponding discrete region of the portion of the environment 102. Each discrete region may represent a tile, such that the union of all tiles covers the portion of the environment 102 (i.e. the discrete regions tesselate the portion of the environment 102). In some examples, the discrete region may be a square, a hexagon, a triangle amongst other examples. The discrete regions may form a semantic segmentation map of the environment 102. The discrete regions may have any area, and may be based on a desired resolution for the set of vectors 122. In examples, the discrete regions may have an area between 0.001 m² to 100 m², such as 0.5 m², 1 m², or 2 m².

The set of vectors 122 in the examples scenario 100 are computed from the frame of reference of an observer at rest with respect to the road 106. It is understood that the set of vectors 122 may be computed for some other frame of reference. For example, the set of vectors 122 may be determined for a frame of reference of an observer fixed to the vehicle 104, in which case the vectors 124 may provide an indication of the relative flow of traffic with respect to the vehicle 104. It is also understood that an appropriate transformation may be applied to vectors determined for a first frame of reference to determine vectors for a second frame of reference.

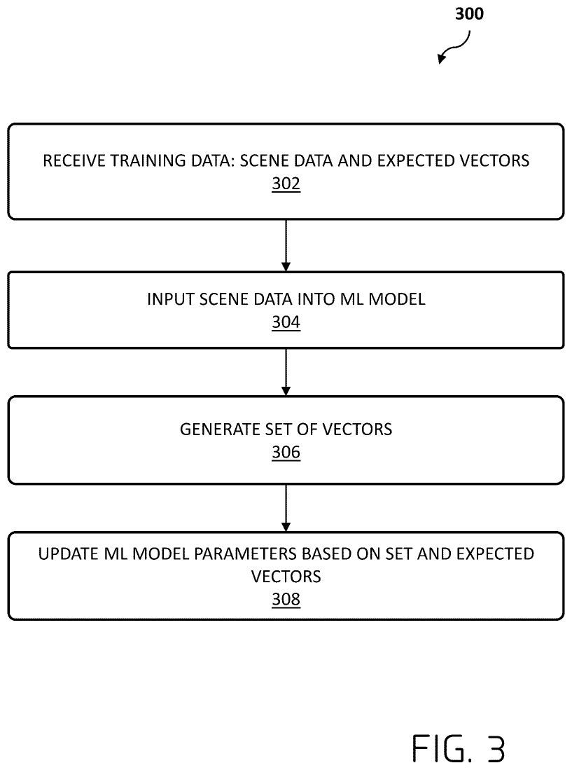

The machine learning model 120 may comprise any suitable model. For example, the machine learning model may be a top-down deep learning model. The machine learning mode may be configured to handle spatial data, directional data, and/or continuous outputs. The machine learning model may comprise such machine learning models as convolutional neural networks (CNNs), generative adversarial networks (GANs), recurrent neural networks (RNNs), long short-term memory networks (LSTMs), variational autoencoders (VAEs), graph neural networks (GNNs), or physics-informed neural networks (PINNs). The type of data provided to the machine learning model 120 may depend on the particular model used. An example process 300 for training the machine learning model 120 using sensor data is provided in FIG. 3.

The vectors 124 making up the set of vectors 122 indicative of traffic flow are determined via the machine learning model 120 in the example scenario 100 shown in FIG. 1. However, it is understood that the set of vectors 122 may be determined in some other manner. For instance, at least part of the set of vectors 122 may be determined using any suitable computational model, other than machine learning models. The set of vectors 122 may be precomputed for a portion of the road 106 wherein the vehicle 104 is located and/or determined using a different procedure. Where at least part of the set of vectors 122 is predetermined, this part of the set may be stored, either on a computing device on the vehicle 104, or in a remote computing device and transmitted to the vehicle 104. The set of vectors 122 may be predetermined using any known process. In some examples, the predetermined set of vectors is generated prior to use in the example scenario 100 by a machine learning model, such as the machine learning model 120.

In some examples, the set of vectors 122 may be determined by estimating the speed and heading of vehicles 112a-j in the environment, perhaps based on sensor data, and then extrapolating those speeds and headings to determine the set of vectors 122. Extrapolation could be performed using any known suitable algorithm. Vectors 124 in such a set of vectors 122 may then indicate a speed and heading at positions in between positions associated with the vehicles 112a-j, thereby providing an indication of traffic flow through the environment, based on current environmental conditions.

In the example scenario 100, the set of vectors 122 may then be provided to the planning system 134. Generally, the planning system 134 may be configured to determine a planned trajectory for the vehicle 102 to follow. In various examples, the planning system 134 may be configured to determine, alter and/or validate trajectories for the vehicle 104 to follow when traveling according to the planned path. In various examples, the planning system 134 may be configured to determine trajectories for the vehicle 104 to follow at a pre-determined interval, such as every 0.1 seconds, 0.05 seconds, or the like. In some examples, the planning system 134 may determine the vehicle trajectory associated the vehicle utilizing techniques such as those described in U.S. patent application Ser. No. 16/805,118, filed Feb. 28, 2020 and entitled “System and Method for Adjusting a Planned Trajectory of an Autonomous Vehicle,” the entire contents of which are incorporated herein by reference for all purposes.

In the example scenario 100, the planning system 134 generates instructions to control the vehicle 104 based at least in part on the set of vectors 122. For instance, an intended route of the vehicle 104 may be to transition from the first lane 108a into the second lane 108b. As described above, the speed of vehicles 112a-c in the first lane 108a is faster than the speed of vehicles in the second lane 108b. This is captured in the set of vectors 122, where the magnitude of vectors 124 associated with positions in the second lane 108b is less than the magnitude of vectors 124 associated with positions in the first lane 108a.

Accordingly, the planning system 134 may use the set of vectors 122 to generate instructions that cause the vehicle 104 to slow down as it moves into the second lane 108b. At the same time, the planning system 134 may determine a trajectory for the vehicle 102 that does not enter the third and fourth lanes 108c, 108d having oncoming traffic. For example, the planning system 134 may be disincentivized to cause the vehicle 104 to enter the third and fourth lanes 108c, 108d based on the set of vectors 122. This therefore does not require the planning system 134 to identify oncoming traffic lanes. Rather, a determined trajectory may be favored that does not move the vehicle 104 into a region where the vectors 124 in the set of vectors 122 are at a particular angle with respect to a current heading of the vehicle 104. In a similar fashion, the vehicle 104 may be disincentivized to enter regions where no vectors are present, as these regions are not associated with any traffic flow. Disincentivization may be achieved via any suitable means. In some examples, a cost may be associated with a determined trajectory, where the cost is at least partially based on the set of vectors 124. A trajectory associated with a higher cost may be indicative of a trajectory that moves out of or against a traffic flow. A trajectory having a lowest cost may be implemented, for example, and this trajectory may be one that most closely aligns with the flow of traffic through the environment. In another example, a cost assigned to a given trajectory can include or account for the flow of traffic or flow vectors associated with the given trajectory.

This concept can be taken further to favor trajectories where at no point along those trajectories does an angle between the vehicle's current heading and a vector associated with a position at or near to the vehicle 104 go above a threshold angle. Angles above the threshold angle may be an indication that the vehicle 104 will move out of an intended traffic flow. Such a threshold may be predetermined or determined dynamically. The threshold may be learned, for example using one or more further machine learning models. Note that non-zero angles below the threshold may be an indication of a turn in the road rather than an indication that the vehicle 104 is moving outside the flow of traffic, for example.

Thus, even in scenarios where a road has no road markings or where road markings are difficult to identify such as in dark or foggy conditions, and wherein it may be difficult to identify lane directions, a set of vectors can be determined that characterizes traffic flow direction, and which can be used to control the vehicle 104.

In the example scenario 100, the vehicle 104 may be controlled entirely based on the set of vectors 122. For example, the vehicle 104 may be controlled to stay within a particular directionality of traffic at a speed associated with the magnitudes of the vectors 124 at various positions throughout the environment 102. In other examples, the set of vectors 122 may be partially used, and in other examples the set of vectors 122 may be disregarded and not used. Thus, the set of vectors 122 provides the planning system 134 with an additional modality by which to make decisions about how to control the vehicle 104 as it traverses the environment 102. The extent to which the set of vectors 122 is used may be predetermined or may be a dynamical decision, perhaps based on the complexity of the current transportation and/or environmental conditions.

In various examples, a tracker component (not shown) associated with the vehicle 104 may be configured to determine one or more control signals to send to a drive system to control the vehicle 104 according to a new trajectory. In various examples, the control signal(s) may include instructions to modify settings associated with one or more components of a drive system of the vehicle 104 (e.g., motor, engine, transmission, steering components, braking components, etc.). As a non-limiting example, the tracker component may provide an instruction to a power source to supply power to one or more motor controllers to cause a certain torque to be applied to one or more wheels (and, in turn, a desired acceleration or velocity of the vehicle). In such examples, the tracker component may be configured to cause the vehicle to be controlled according to the new trajectory including, without limitation, to move from a current state (location, orientation, speed, etc.) to a state defined by the trajectory. As discussed herein, the vehicle control system may be associated with a vehicle computing system.

The vector-based representation of traffic described above enables a detailed characterization of traffic flow patterns across the environment 102. Each vector 124 in the example scenario 100 represents both directional and speed information at specific positions, allowing for modelling of complex traffic behaviors. This comprehensive representation accounts for varying speeds across lanes 108a-d, merging behaviors, and other nuanced traffic dynamics.

FIG. 2 illustrates an example method 200 that can be performed in the scenario 100 illustrated in FIG. 1, wherein the data that is used to determine the set of vectors 122 comprises sensor data. The method 200 may be performed by a computing system associated with the vehicle 104, such as the computing system 118.

At block 202, the computing system may receive data indicating information about the environment 102 near the vehicle 104. The example environment 102 includes traffic movement as described above with regards to FIG. 1. The data in this example comprises image data 210 from a camera mounted on the vehicle 104. As can be seen in FIG. 2, the image data 210 represents a field of view of the camera at a first time, T1, which corresponds to a point time associated with the scenario 100 illustrated at the top of FIG. 1. The data may also include map data or other information indicative of the environment 102 in the vicinity of the autonomous vehicle 104.

At the first time, T1, the vehicle 104 is moving according to a first trajectory, and has a first speed and direction (or yaw) indicated by vector 208. The first trajectory may have been determined based at least in part on sensor data and predefined traffic rules. These traffic rules may include speed limits, lane restrictions, right-of-way regulations, or traffic signal requirements. The first trajectory may, additionally or alternatively, have been determined at least partially based on a previous set of vectors indicative of a traffic flow at a time before T1.

At block 204, the computing system may determine a set of vectors 122 based on the received data and using a machine learning model 120. As described above, at least a portion of the data may be input directly to the machine learning model 120. In other examples, at least a portion of the data may undergo some form of preprocessing before being provided to the machine learning model 120. In any case, the determined vectors 124 have directions and magnitudes representing traffic movement in the environment 102. Each vector 124 is associated with a position in the vicinity of the autonomous vehicle 104 and provides information about both the direction and speed of traffic movement at that position.

At block 206, the computing system may control the autonomous vehicle 104 based on the determined set of vectors 122. Control instructions may be determined by the computing system, that cause the vehicle 104 to move according to a second, different, trajectory such that at a later time, T2, the vehicle 104 is moving according to at least one of a new speed or direction, indicated by vector 212. The method 200 therefore allows the vehicle 104 to navigate through traffic 110 while accounting for the movement patterns indicated by the set of vectors 122. A change in trajectory based on the set of vectors 122 in this example is purely illustrative, and it is understood that the set of vectors 122 may indicate that it is appropriate (e.g. safe) to continue according to a previously determined trajectory.

FIG. 3 illustrates a process 300 for training the machine learning model 120 described in relation to FIG. 2. The training process 300 enables the machine learning model 120 to accurately predict traffic flow patterns, in this case based on scene data (e.g. image data).

At block 302, training data may be received comprising scene data representing a scene with an example movement or flow of traffic, and an expected set of vectors. The expected set of vectors comprises vectors having directions that indicate known directions of the example movement of traffic. The known direction of the example movement of traffic may be a direction associated with a lane of a road in the scene. The vectors also have magnitudes that indicate known speeds associated with the example movement of traffic at respective positions within the scene. The known speed associated with the example movement of traffic may, for example, be a speed limit of the road.

The scene data may be based on a real or simulated scene. The scene data may include sensor data such as camera images, lidar point clouds, or radar data showing traffic patterns in various road configurations and conditions. For instance, the scene may include a portion of a road, a vehicle, and a signal that is not being adhered to by the vehicle. The scene may comprise one or more anomalies, that is agents or objects that are not behaving as expected. The scene data may represent a snapshot of the scene at a particular time, or may represent a plurality of snapshots of the scene over a period of time.

At block 304, the scene data may be input into the machine learning model 120. As described above, the scene data may undergo some form of preprocessing for suitability for provision to the machine learning model 120. In some examples, the scene data may be transformed into a top-down view, similar to that illustrated in FIG. 1.

At block 306, the machine learning model 120 processes the input scene data to generate a set of vectors. The generated set of vectors represent the model's current prediction of traffic movement patterns based on its training progress.

At block 308, parameters of the machine learning model 120 are updated based on comparing the set of vectors generated by the model with the expected set of vectors. For example, in a convolutional neural network implementation, the parameters that may be updated include convolution filter weights, bias terms, and fully connected layer weights. The parameter updates work to minimize differences between the predicted and expected vectors, thereby improving the model's ability to accurately represent traffic movement patterns. The updating process may utilize various techniques such as backpropagation and gradient descent to adjust the model parameters.

The training process 300 may be repeated iteratively with different scenes and corresponding expected vector sets until the machine learning model 120 achieves a desired level of accuracy in predicting traffic movement patterns. This iterative training enables the model to learn complex relationships between scene features and corresponding traffic flow representations.

The training approach using known traffic patterns and expected vectors enables accurate learning through validated examples. The machine learning model receives concrete examples of actual traffic movements along with their corresponding vector representations. This example supervised learning process 300 allows the model to adjust its parameters based on real-world or simulated traffic data, leading to improved predictions of movement patterns.

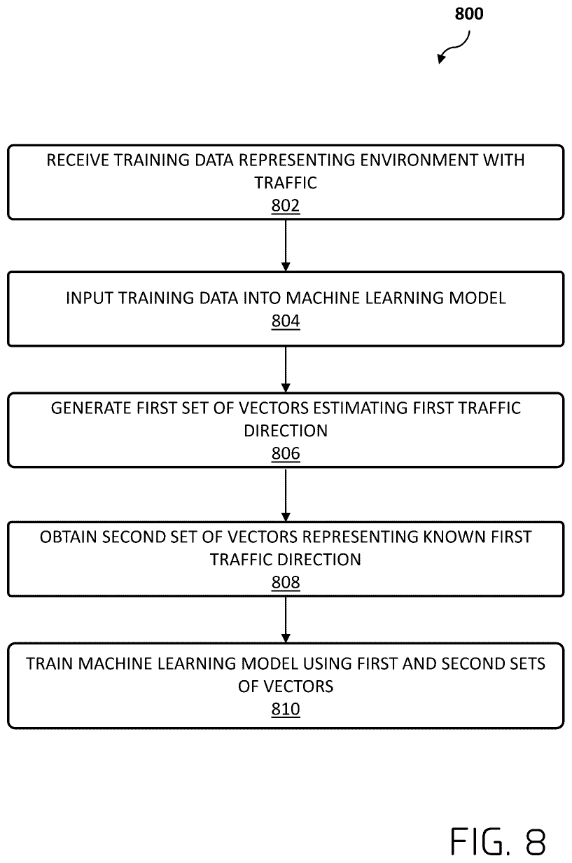

While the method 300 is specific to the use of training based on scene data, it is understood that the training may use different types of data, such as predetermined map data. In this case, the training may be based on known road layouts, associated speed limits, lane directions etc. without requiring additional input based on known vehicle velocities in a particular scene. A more general training process will be described below with regards to FIG. 8.

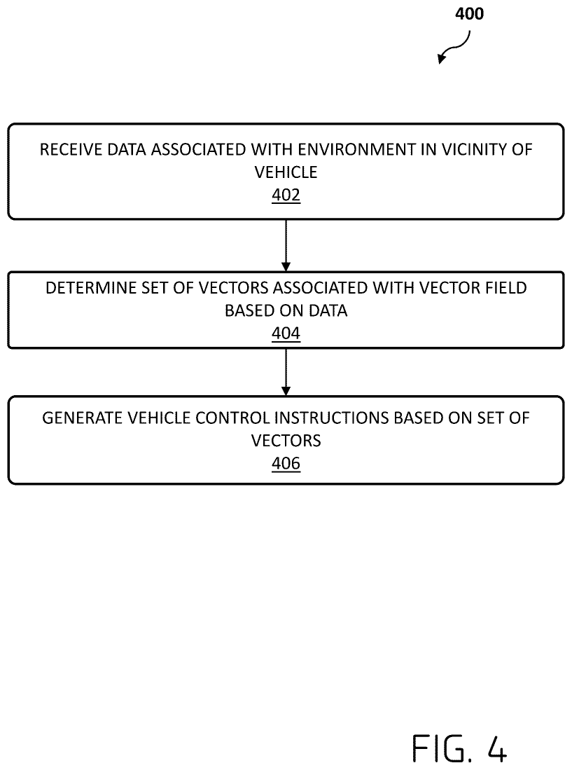

It is understood that the examples illustrated in FIGS. 1, 2 and 3 are not exhaustive. In particular, FIGS. 1 and 2 illustrate a basic example that utilizes a determined set of vectors 122 in controlling a vehicle 104. FIG. 4 illustrates a general process 400 for determining and utilizing vectors associated with traffic flow. The process 400 can be performed by one or more computing devices associated with a vehicle, such as the vehicle 104 and/or the vehicle 1502 illustrated in FIG. 15. The one or more computing devices may be associated with a vehicle control system.

At 402, data associated with an environment in a vicinity of a vehicle may be received. As described above, the vehicle may be moving through the environment or may be stationary within the environment. The vehicle may be an autonomous vehicle. The environment may comprise one or more other vehicles, a portion of a transportation network, signals and/or signs associated with the transportation network, amongst other objects.

The data may comprise any suitable data associated with the environment including, but not limited to, sensor data, map data, and environmental condition data. Sensor data from various types of sensors may be used to detect objects, movements, and conditions in the environment. The sensor data may also be used to determine information about a portion of the transportation network being traversed by the vehicle. Map data may be used to indicate predetermined properties of the portion of the transportation network such as road layout, transport regulations applicable to that portion of the transportation network, a presence of signals, and so on.

At 404, a set of vectors associated with a vector field may be determined based on the received data. The vector field represents at least a traffic direction at each point in the environment. That is, each position in the environment has an associated vector having a direction indicative of the traffic direction at that position. For example, the set of vectors may provide information about a flow of traffic through the environment. In some examples, the vector field may also represent a speed of traffic at each position in the environment.

The set of vectors that is determined may be a discretized representation of the vector field. A machine learning model may determine the set of vectors based on the received data, as has been described above. In other examples, the set of vectors may be precomputed for the portion of the transportation network wherein the vehicle is located. For instance, the data may be location data indicative of a current geographic location of the vehicle. This may be used to identify a set of vectors indicative of a traffic direction at that geographic location.

At 406, instructions to control the vehicle are generated based on the set of vectors. These instructions can guide the vehicle in responding to the detected traffic and/or environmental conditions. The instructions may account for factors such as varying speeds across lanes, presence of oncoming traffic, and overall traffic flow patterns represented by the vector field.

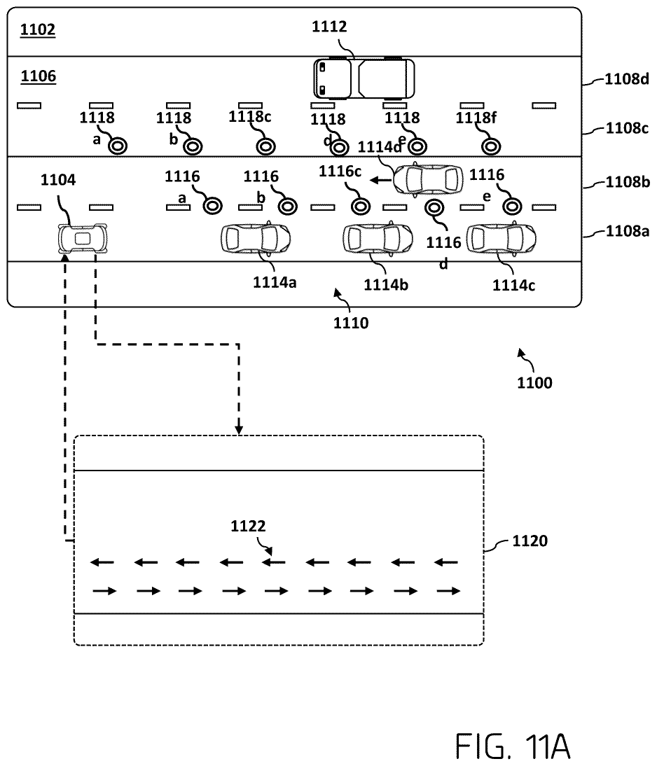

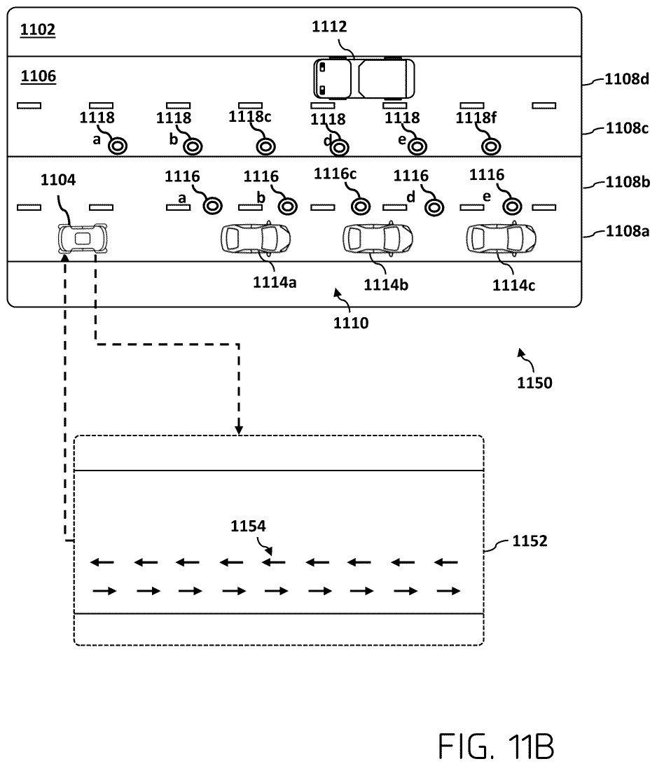

In some examples, the instructions may have already been generated prior to the determination of the set of vectors. In this case, a trajectory associated with the set of instructions may be compared to the set of vectors. For instance, the computing system may, for a certain number of points on the trajectory, compare the direction and/or speed associated with the trajectory with vectors in the set of vectors associated with those points. If a difference between the direction and speed associated with the trajectory and the vectors is within certain thresholds, then the trajectory may be validated and the set of instructions used to control the vehicle. Note that the planning system may compute a plurality of possible trajectories for the vehicle to follow at any time, so that each of these possible trajectories may be compared to the set of vectors and a subset of these trajectories validated. In this way, the set of vectors may act as a validation means to identify appropriate trajectories from a plurality of possible trajectories.

Where current environmental data is used to determine the set of vectors, the process 400 enables continuous monitoring and response to traffic conditions through vector-based analysis. The generated vectors may provide a comprehensive representation of traffic movement that can be used to inform vehicle control decisions. This allows for adaptive navigation that accounts for real-time traffic flow patterns across the environment. This also allows for suitable navigation in unusual transportation scenarios, some of which will be described in further detail with regards to FIGS. 11-14.

The vector field representation enables processing traffic patterns through mathematical modeling. The vectors capture directional flow information in a format suitable for computational analysis. This mathematical framework allows systematic characterization of complex traffic behaviors.

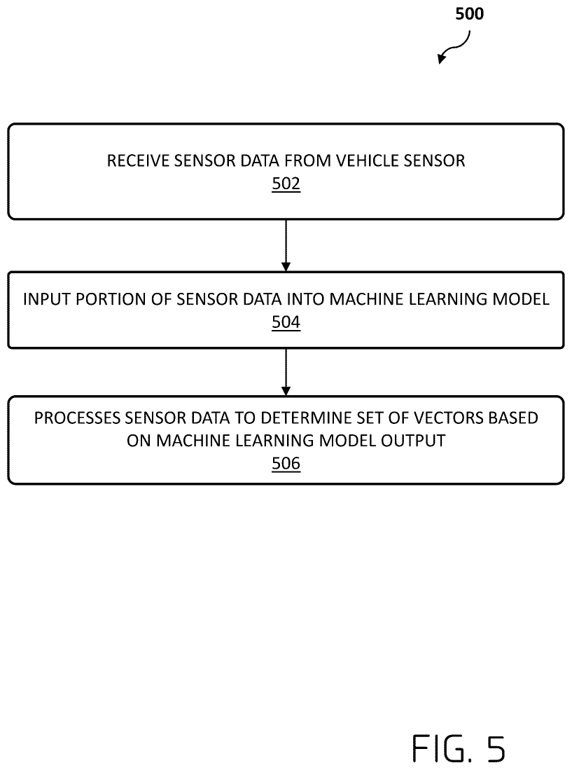

FIG. 5 illustrates a method 500 for processing sensor data from a vehicle to determine the set of vectors. One or more sensors associated with the vehicle may generate the sensor data which is received at block 502. The one or more sensors may be mounted on, integrated with, or remote from the vehicle. Example sensors include cameras, lidar sensors, radar sensors, ultrasonic sensors, or other sensing devices capable of capturing information about the environment.

At block 504, at least a portion of the received sensor data may be input into a machine learning model. The machine learning model may be any suitable machine learning model, such as the machine learning model illustrated in FIGS. 1 and 2. For instance, the machine learning model can include various types of models such as neural networks, convolutional neural networks, recurrent neural networks, or other suitable machine learning architectures trained on vehicle sensor data.

Different portions or subsets of the sensor data may be selected for input into the machine learning model. The selection may be based on various factors such as, but not limited to computational resources available. For instance, a subset of the sensor data corresponding to a portion of a transportation network directly in front of the vehicle may be selected.

As discussed above, the sensor data may be processed into a form that is suitable for provision to the machine learning model. In some examples, the machine learning model may be configured to receive the sensor data as generated by the sensor. In other examples, one or more further machine learning models may be used to determine a transportation network layout based on the sensor data. The one or more further machine learning models may be used to identify and classify one or more objects based on the sensor data. In this way, the sensor data may be processed into an abstract representation of the environment that the machine learning model processes into a set of spatially-distributed vectors.

The machine learning model may be configured to process the sensor data at block 506. As mentioned, the machine learning model can include various types of models such as neural networks, convolutional neural networks, recurrent neural networks, or other suitable machine learning architectures trained on vehicle sensor data. The vectors are associated with a vector field that represents at least a traffic direction at each point in the environment, and in this example can represent various characteristics or features extracted from the sensor data, such as object positions, trajectories, velocities, accelerations, or other parameters derived from the sensor measurements. The set of vectors therefore provides a representation of the processed sensor information that can be used for further analysis and/or decision making related to the vehicle operation.

The example method 500 provides an integration of sensor data with machine learning which enables continuous adaptation of the set of vectors (and associated underlying vector field) based on real-world conditions encountered by the vehicle. The processing of sensor measurements through the machine learning model may allow the vectors to be dynamically updated as the environment changes, thereby providing responsiveness to actual conditions.

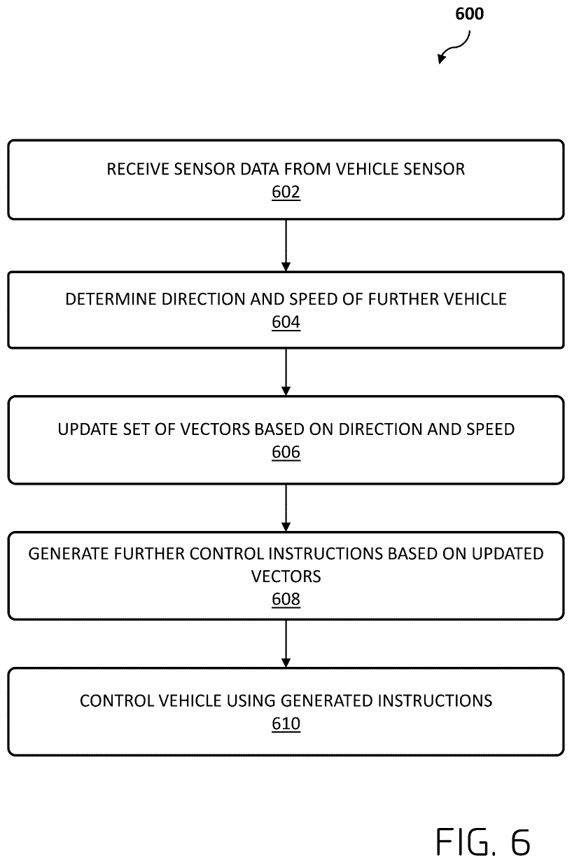

FIG. 6 provides an example method 600 wherein the set of vectors may be updated based on current environmental conditions. At block 602, the method 600 includes receiving sensor data from a sensor associated with a vehicle. The sensor data may be similar to the sensor data described with relation to block 502 in the method 500.

At block 604, a direction and speed of a further vehicle in the environment may be determined based on the received sensor data. The direction may be determined based on a known field of view of the one or more sensors used to generate the sensor data. The direction may be relative to the vehicle's current position and heading. The further vehicle's speed may be determined by tracking the further vehicle's position over time using successive sensor measurements, or by combining sensor measurements from different sensors at different times, for example.

At block 606, a set of vectors is updated based on the determined direction and speed of the further vehicle to generate an updated set of vectors. An initial set of vectors may have been determined at an earlier time. The initial set of vectors may have been determined based on map data associated with a geographic location of the vehicle, thereby providing a historical representation of the traffic flow at that geographical location at the time that the map data was obtained. In another example, the initial set of vectors may have been determined based on sensor data captured at an earlier time (i.e. before the sensor data used to determine the further vehicle's direction and speed was obtained).

The initial set of vectors may therefore be updated based on the determined direction and speed of the further vehicle. The updating may involve inputting the sensor data into the model used to determine the initial set of vectors, to generate the updated set of vectors. The updating may involve inputting the sensor data into the model used to determine the initial set of vectors, and comparing an intermediate set of vectors output by the model with the initial set of vectors. The comparison may involve applying an average between the initial set of vectors and the intermediate set of vectors at each position. This may reduce an effect of outliers in the current environment. For instance, if the further vehicle is moving above a speed limit, the updated set of vectors may not be updated to include vectors having magnitudes indicative of a speed above the speed limit. Other examples of updating the initial set of vectors are possible.

At block 608, further instructions to control the vehicle may be generated based at least in part on the updated set of vectors. These control instructions may specify adjustments to the vehicle's speed, heading, or path to maintain appropriate operation given the presence and movement of the further vehicle.

The method continues to block 610 where the vehicle may be controlled using the generated instructions. The control may include adjusting the vehicle's acceleration, braking, steering, or other operational parameters according to the generated instructions to execute the desired vehicle response.

The steps of the method 600 may be repeated continuously or at regular or non-regular intervals to maintain current information about the environment and appropriate vehicle control as conditions change. The sensor data collection, vector updates, and instruction generation may occur multiple times per second to enable responsive vehicle control.

The continuous monitoring and processing of sensor data from surrounding vehicles enables responsive navigation in dynamic traffic environments. The real-time updates to the set of vectors incorporate changing positions, speeds and trajectories of nearby vehicles. This allows a vehicle control system to adapt smoothly to evolving traffic patterns and maintain appropriate spacing and routing.

The method 600 involves updating the set of vectors based on the position, heading and speed of a further vehicle. It is understood that the set of vectors (i.e. an initial set of vectors) may be updated based on other environmental factors. For instance, an initial set of vectors may be updated based on a detected change in road layout, perhaps due to roadworks. This may be the case where the initial set of vectors has been determined for a known layout of a portion of road, and where a vehicle detects a change to the known road layout and the set of vectors are updated accordingly.

The methods 400-600 have so far referred to a set of vectors that may be associated with a vector field. A vector field is an assignment of a vector to each point in space, and it is understood that an assignment of a single vector field may be too restrictive to capture more complex traffic flows, such as those involving intersections where vectors indicative of a direction of traffic at some points may be associated with two, different, directions. Thus, in some examples, it may be appropriate to determine two or more sets of vectors to represent traffic flow through an environment more accurately.

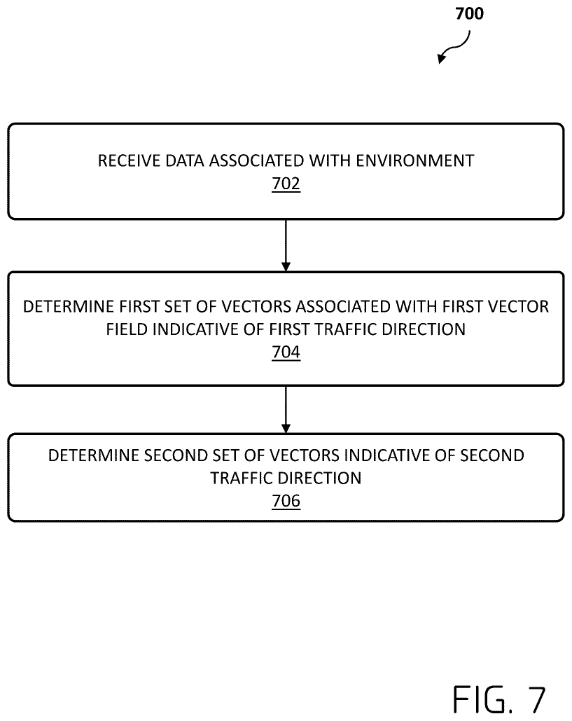

An example of determining two or more sets of vectors will now be described with reference to method 700 shown in FIG. 7. At block 702, the method 700 involves receiving data associated with an environment. The data may be similar to any of the data described above with reference to the methods 400-600, and can include information about objects, structures, or other elements present in the environment.

At block 704, a first set of vectors associated with a first vector field may be determined based on the received data. The first vector field may be indicative of a first traffic direction in the environment. The first traffic direction may be associated with one or more lanes of a road. The first traffic direction may be associated with one or more roads of a road network comprising a plurality of roads, for example a crossroads or a junction.

At block 706, a second set of vectors can be determined based on the received data. The second set of vectors may be indicative of a second traffic direction in the environment. The second traffic direction may differ from the first traffic direction, allowing for a representation of multiple traffic flows within the same environment. The second set of vectors may be associated with a second vector field. In other examples, the second set of vectors may be associated with the first vector field. In some examples, a vector in the first set may be associated with a same position as a vector in the second set, and have a different direction compared with that of the second vector. Thus, the first and second sets of vectors represent a dual distribution of the traffic flow in an environment.

The first and second sets of vectors may be determined simultaneously, or may be determined separately. For example, where a machine learning model is used to determine the first and second sets of vectors, the model may be trained to identify a one or more flows of traffic and therefore determine a corresponding one or more sets of vectors based on a single input of data. Note that the identification of first and second sets of vectors is illustrative, and alternatively a single set of vectors may be determined from which the first and second sets of vectors described here may be identified.

In other examples, the data may be processed to form at least two portions of the data, that are separately input to a machine learning model to determine the first and second sets of vectors. For instance, the data may be sensor data, and vehicles associated with a first direction may be identified from the sensor data, for example using known classification algorithms. A portion of the data associated with the vehicles with the first direction may be input to a machine learning model to determine the first set of vectors. This may be repeated based on identifying vehicles associated with a second direction.

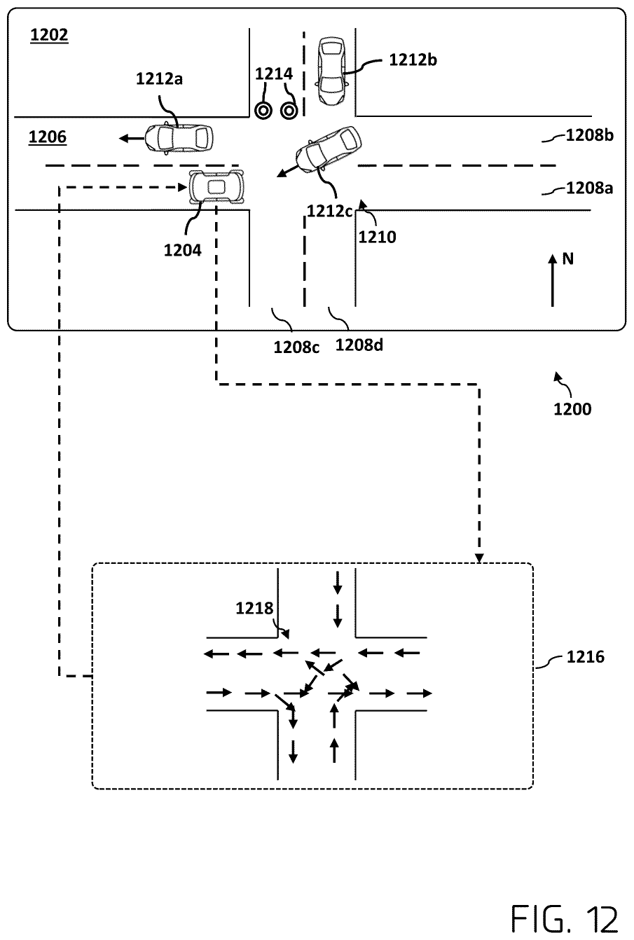

The first and second sets of vectors may provide a more comprehensive representation of different traffic directions within the environment. The first set of vectors can model traffic moving in one direction while the second set of vectors may model traffic moving in another direction, possibly intersecting. It is understood that more than two sets of vectors may be determined for any given scenario. This multi-directional modeling approach allows for a more complete understanding of complex traffic patterns where vehicles may travel in various directions throughout the same area. FIG. 12, which will be described below provides an illustrative example scenario 1200 in which a plurality of sets of vectors may be determined.

The method 700 is also applicable to scenarios where the first set of vectors are associated with a first type of object (e.g. one of car, bicycle, vehicle, scooter, boat, pedestrians, animals, etc.), and the second set of vectors are associated with a second type of object (e.g. a different one of car, bicycle, vehicle, scooter, boat, pedestrians, animals, etc.). In this way, a more comprehensive representation of the environment can be generated. In an example, the first set of vectors may be associated with motorized vehicles such as cars and/or motorbikes and the second set of vectors may be associated with non-motorized vehicles such as pedestrians and/or push bikes. In this example, the vehicle may be controlled to move in a flow associated with the first set of vectors, and disincentivized to enter regions associated with the second set of vectors. The second set of vectors may be indicative of a flow of pedestrians and may include details of pedestrian crossings and locations where no footpath is present where pedestrians are required to walk on a road. A motorized vehicle may be controlled to factor in these road features. It will be appreciated that a set of vectors indicating flow of traffic or flow of moving objects do not necessarily have to be projected onto or associated with a road surface, pavement/side walk, or walkway, as moving objects can be travelling out of normal surfaces where objects may be flowing. It will be further appreciated that a flow vector could be assigned to or associated with one of these abnormal surfaces (surfaces that are not roads, pavement/side walk, or walkways) if more than one object travels through such abnormal surfaces in the same or similar direction (as to differentiate from an out of distribution movement of an object or an anomalous movement of an object).

Multiple sets of vectors associated with different object types may also improve anomaly detection, for instance, allowing for anomaly detection for each of the different object types (e.g. jaywalkers and anonymous three-point turning vehicles). For example, individual objects, such as vehicles, pedestrians, and bicyclists, in an environment may be identified, and their heading and/or speed determined. The determined heading and/or speed may be compared to a respective set of vectors (associated with a flow of that type of object) to identify objects that are anomalous. For example, objects that are not travelling according to their corresponding set of vectors may be identified and labelled as anomalous and/or exhibiting out of distribution behaviour. These objects may be taken into account when generating a set of instructions to control the vehicle.

FIG. 3 illustrated an example process for training a machine learning model based on scene data. FIG. 8 illustrates a more general method 800 for training a machine learning model to determine sets of vectors associated with traffic flow. The method 800 includes receiving training data representing an environment at block 802. The environment may relate to a single instance of time (e.g. a snapshot of a scene) or may relate to multiple instances of time (e.g. multiple snapshots of a scene captured over some period of time). The environment may, or may not, comprise vehicles forming traffic. In some examples, the machine learning model may be trained on training data that comprises environments with and without traffic. In that way, the machine learning model may learn to determine sets of vectors in different scenarios including different numbers of vehicles present.

The training data may be based on real data captured by real devices, or may be based on simulated data. The training data can include sensor data collected from one or more sensors, such as cameras, lidar sensors, radar sensors, or other sensing devices capable of detecting traffic patterns and movement.

At block 804, the training data may be input into a machine learning model. As discussed above, the machine learning model can be implemented using various architectures, such as neural networks, convolutional neural networks, recurrent neural networks, or other suitable machine learning frameworks configured to process traffic-related data.

The method 800 proceeds to block 806, where a first set of vectors is generated by the machine learning model based on the input training data. Each vector in the first set of vectors represents an estimate of a first traffic direction at corresponding positions within the environment. These vectors can indicate the predicted direction of traffic flow at various locations throughout the environment.

At block 808, a second set of vectors is obtained, where each vector in the second set represents known first traffic directions at respective positions in the environment. The second set of vectors may be included as part of the training data or may be supplied separately. These known traffic directions can be determined from ground truth data, manual annotation, or other reliable sources that accurately indicate actual traffic flow directions.

Where the training data relates to an environment without vehicles present or where vehicles are present but stationary, the second set of vectors may relate to intended known first traffic directions. For example, the traffic directions that would be present were vehicles present and moving in the environment. In this way, the machine learning model may be trained to identify traffic flow patterns even when no vehicles are present or where vehicles are stationary.

The method 800 continues to block 810, where the machine learning model is trained using both the first set of vectors (representing estimated traffic directions) and the second set of vectors (representing known traffic directions). The training process may adjust parameters of the machine learning model to minimize the difference between the estimated and known traffic directions, thereby improving the model's ability to accurately predict traffic directions in new, perhaps previously unseen, environments.

Once trained, the machine learning model can be used to generate sets of vectors indicative of traffic flow in various environments based on input data relating to those environments. The machine learning model may then be implemented in the methods 200, 400-700, for example.

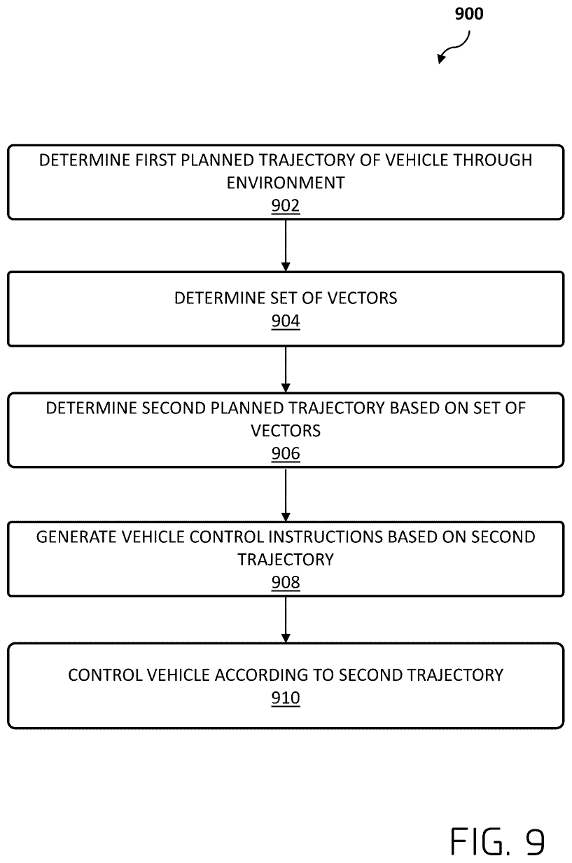

FIG. 9 illustrates an example of how various techniques described herein may be implemented in controlling a vehicle. FIG. 9 shows a method 900 that may be implemented using one or more computing devices, processors, or controllers associated with the vehicle.

At block 902, a first planned trajectory of the vehicle through the environment can be determined. The first planned trajectory may represent an initial path calculated for the vehicle based on various factors such as destination, road conditions, traffic patterns and predefined traffic rules. An example predefined traffic rule may be stopping in the presence of a stop signal and a red traffic signal. The first planned trajectory may be based on sensor data generated by one or more sensors associated with the vehicle.

At block 904, a set of vectors may be determined, as described with reference to the method 400, for example.

Based on the set of vectors determined at block 904, a second planned trajectory of the vehicle through the environment can be determined at block 906. The second planned trajectory may differ from the first planned trajectory and may be calculated to account for additional considerations represented by the set of vectors. For instance, the set of vectors may provide additional contextual information that allows for the determination of a more appropriate planned trajectory for the current scenario.

At block 908, vehicle control instructions can be generated based on the second planned trajectory. These instructions may include specific commands for various vehicle systems such as steering, acceleration, or braking.

The method 900 proceeds to block 910, where the vehicle can be controlled according to the second trajectory using the generated vehicle control instructions. This control may involve adjusting the vehicle's speed, direction, or other operational parameters to follow the second planned trajectory through the environment.

The method 900 may be repeated continuously, periodically, non-periodically and/or at predetermined intervals during vehicle operation to maintain appropriate trajectory control.

The ability to adjust a planned path based on vector field analysis may allow for dynamic adaptation to changing conditions. The vehicle's routing can be continuously optimized by evaluating vectors representing various environmental and operational parameters. This approach enables responsive navigation that can account for real-time changes in the surrounding environment.

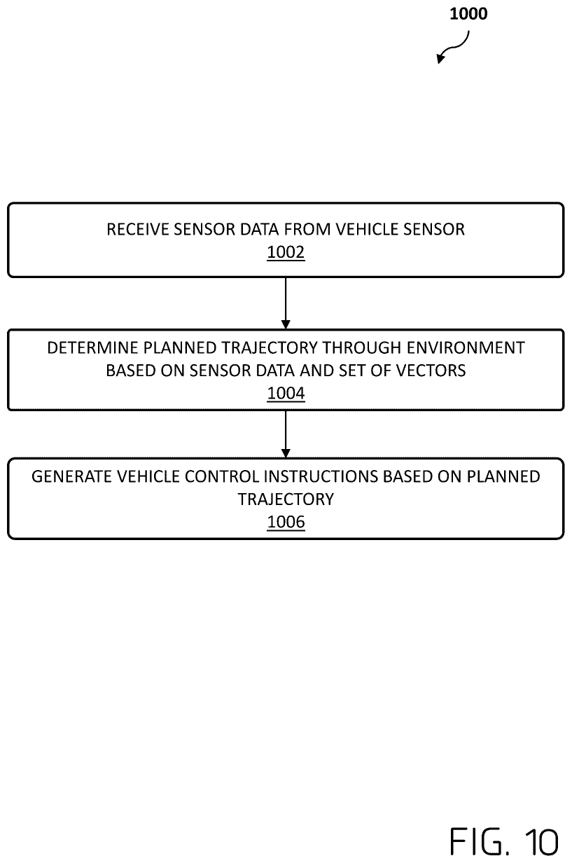

FIG. 10 illustrates a further method 1000 for controlling a vehicle based at least in part on a set of vectors associated with traffic flow. At block 1002, sensor data may be received from one or more sensors associated with the vehicle. The sensors may be any of those described above.

At block 1004, a planned trajectory for the vehicle through the environment is determined based on the received sensor data and a set of vectors. That is, sensor data indicating information about the environment may be combined with a set of vectors that are associated with traffic flow through the environment to determine the planned trajectory. In this way, the set of vectors may influence a vehicle control system's conventional trajectory determination procedure, providing additional contextual information that may be used to adapt the decision-making process in at least some scenarios.

At block 1006, vehicle control instructions are generated based on the planned trajectory. These instructions can include commands for steering, acceleration, braking, or other vehicle control systems. The control instructions direct the vehicle to follow the planned trajectory while maintaining safety and operational parameters.

The techniques described herein will now be further described with regards to certain example scenarios illustrated in FIGS. 11A-14. FIG. 11A illustrates a first of these example scenarios 1100 comprising a vehicle 1104 operating within an environment 1102. The vehicle 1104 may be similar to the vehicle 102 shown in FIG. 1. The environment 1102 includes a road 1106 and a plurality of other vehicles 1114a-c that, along with the vehicle 1104, form traffic 1110 traversing the road 1106. In this example scenario 1100, the vehicle 1104 and the vehicles 1114a-c are illustrated as stationary, while the vehicle 1114d is in motion. The road comprises four lanes, labelled 1108a-d.

Also present in the example scenario 1100 is a construction vehicle 1112 in a fourth lane 1108d and a first set of traffic cones 1116a-e lined along the road 1106 between first and second lanes 1108a, 1108b. A second set of cones 1118a-1118f line the road 1106 along the third lane 1108c. To a driver, the example scenario 1100 may be understood as including construction being carried out in third and fourth lanes 1108c, 1108d, and so which are therefore inaccessible to traffic. The second lane 1108b is understood as relating to traffic associated with a direction opposite that corresponding to the vehicle 1104 and the other vehicles 1114a-c. Thus, traffic that would usually traverse the environment 1102 using all four lanes 1108a-1108d is now restricted to using the first and second lanes 1108a, 1108b.

A vehicle 1104 comprising a vehicle control system (not shown) may not interpret the scenario 1100 as a driver would, because the vehicle control system may use rule-based decisions to generate instructions to control the vehicle 1104 through the environment 1102. The vehicle 1114d moving along the lane 1108b may be considered an anomaly, for example, a vehicle moving in a lane that it should not be moving along. Accordingly, the vehicle 1104 may wait for the vehicle 1114d to pass the vehicle 1104 and then move into, and then along, the lane 1108b.

According to various techniques described herein, a set of vectors 122 may be determined that are associated with traffic flow at respective positions in the environment 1102. Data associated with the environment 1102 in a vicinity of the vehicle 1104 may be obtained and the set of vectors 1120 determined based on that data. FIG. 11A shows schematically, the determination of the set of vectors 1120, wherein the process by which the vectors 1122 is omitted from the FIG. 11A as it is understood that various procedures could be used. For instance, a computing system such as that shown in FIG. 1 may be used, and which may comprise a machine learning model that receives the data and determines the set of vectors 1120. In this example, the machine learning model may have been trained to identify vectors associated with traffic flow in similar scenarios.

As illustrated in FIG. 11A, the set of vectors 1120 comprises vectors 1122 indicative of a traffic direction at respective positions in the environment 1102. The set of vectors 1120 includes a first plurality of vectors indicating a first traffic flow direction substantially aligned, or parallel, with a current heading of the vehicle 1104, and which corresponds to the first lane 1108a. The set of vectors 1120 includes a second plurality of vectors indicating a second traffic flow direction substantially antiparallel to the current heading of the vehicle 1104. The second traffic flow direction has therefore been determined even in the absence of vehicles in the second lane in this example.

The set of vectors 1120 may then be used, at least partially, to generate a set of instructions to control the vehicle 1104. Whereas vehicle control systems operating according to conventional, rule-based, procedures may generate a trajectory that would take the vehicle 1104 from the first lane 1108a into the second lane 1108b, the set of vectors 1120 may be analyzed to determine that the second lane 1108b is associated with oncoming traffic. Accordingly, the set of instructions that are generated in this example scenario 1100 are associated with a trajectory that keeps the vehicle 1104 in the first lane 1108a.

FIG. 11B illustrates a similar example scenario 1150 as that shown in FIG. 11A, but where vehicle 1114d is not present. Therefore, none of the vehicles 1114a-c present in the scenario 1150 are in motion. The scenario 1150 may correspond to the scenario 1100 at a different time.

As described above, the inventors have found that a machine learning model, trained appropriately, can determine an accurate set of vectors even in scenarios where no vehicles are present or where vehicles in the environment are stationary. In the present scenario 1150 then, a generated set of vectors 1152 may still provide an accurate representation of the traffic flow. The set of vectors 1152 determined for the scenario 1150 may be the same as, or at least similar to, the set of vectors 1120 illustrated in FIG. 11A.

The lack of vehicles in the second lane 1108b and the lack of motion of the vehicles 114a-c in the first lane 1108a may cause difficulties for a conventional vehicle control system in generating an appropriate set of control instructions. However, with the additional contextual information provided by the set of vectors 1152, the set of instructions that are generated in this example scenario 1150 may be similar to those generated in the scenario 1100 illustrated in FIG. 11A.

FIG. 12 illustrates a further example scenario 1200 comprising a vehicle 1204 operating within an environment 1202. The vehicle 1204 may be similar to the vehicle 104 shown in FIG. 1 or the vehicle 1104 shown in FIGS. 11A and B. The environment 1202 includes a road section 1206 comprising four lanes 1208a-d that form a crossroad junction. In this road section 1206, vehicles approaching the crossroad junction may normally be able to take one of three possible routes out of the junction (not including the possibility of performing a U-turn). In this example scenario 1200 however, a set of cones 1214 are present in one of the road portions that prevents vehicles from exiting the crossroad junction in a northward direction (the direction indicated by the arrow labelled “N” in the FIG.). Vehicles travelling in an opposite direction, such as vehicle 1212b may still be able to enter the crossroad junction.

Such an example scenario 1200 may cause a vehicle control system operating according to rule-based procedures to implement an unsatisfactory set of control instructions where the vehicle 1204 intends to take the northward directed portion of road because there is a vehicle 1212b in the lane expected to be taken by the vehicle 1204. In some cases, this may have an impact on safety of passengers of the vehicle 1204 and/or passengers of other vehicles 1212a-c in the scenario 1202.

The traffic 1210 formed by the vehicles 1204, 1212a-c in this scenario is more complex than that illustrated in FIG. 1 since there is an intersection junction present and a lane closure. As before, data associated with the environment 1202 in a vicinity of the vehicle 1204 may be used to determine a set of vectors 1216 associated with a vector field that is indicative of a traffic direction in the environment 1202. In this scenario 1200, a vehicle control system may implement at least some aspects of the method 700 of FIG. 7 to generate a plurality of smaller sets of vectors, that combined form the set of vectors 1216. In this case, each of the smaller (sub)sets of vectors may be associated with a single traffic direction that enters the crossroad junction via a first route and exits the crossroad junction by a second route.

As can be seen in FIG. 12, the set of vectors 1216 determined for this road section 1206 includes vectors that may be associated with the same or similar positions within the environment 1202.

The presence of the cones in the lane 1208c and the oncoming vehicle 1212b in the lane 1208d may cause the set of vectors to be generated that do not include a flow of traffic into the crossroad junction that exits the crossroad junction in the northward direction.

In this case then, a calculated trajectory through the crossroad junction may be made in accordance with a traffic flow associated with an intended direction of travel. In this scenario 1200, the vehicle 1204 may intend to travel northward, but as indicted by the set of vectors 1216, there is not an associated flow of traffic that would take the vehicle 1204 from its current position to the lanes 1208c, 1208d in a northward direction. Accordingly, the vehicle computing system (not shown) may interpret the set of vectors 1216 to mean that the intended northward route cannot be traversed. A navigation system associated with the vehicle may then identify an alternative route to a desired destination. The alternative route may be at least partially based on the set of vectors 1216. For example, the alternative route may be in accordance with a flow that is possible from the vehicle's current position and heading and an exit from the crossroad junction.

As described above, trajectories that cause an angle between a vehicle's current heading and a vector 1218 in the set of vectors 1216 to be greater than a threshold angle may be discounted, or at least disincentivized from being implemented. In this example, because there may be multiple vectors 1218 associated with a single position in the environment, each having different angles, the vehicle control system may verify that an angle between a current heading of the vehicle 1204 and (at least) one of the multiple vectors 1218 is less than a threshold angle, and then determine a trajectory based on the smaller set of vectors that includes that one of the multiple vectors.

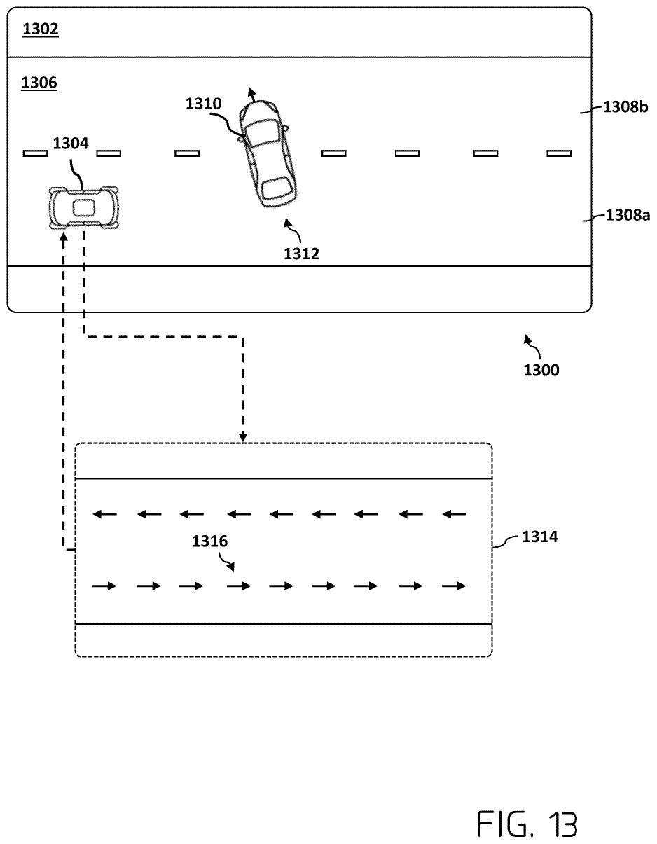

FIG. 13 shows a further example scenario 1300 involving an environment 1302 including a vehicle 1304 traversing a road 1306 having two lanes 1308a, 1308b. The vehicle 1304 may be similar to the vehicle 104 shown in FIG. 1 the vehicle 1104 shown in FIGS. 11A and B, or the vehicle 1204 shown in FIG. 12. A further vehicle 1310 is present. Together, the vehicle 1304 and the further vehicle 1310 may be considered to form traffic 1312. The further vehicle 1310 is performing a three-point turn across both of the lanes 1308a, 1308b. This may be unexpected behavior as far as a vehicle control system configured to control the vehicle 1304 is concerned, and so conventionally, the vehicle control system may struggle to generate appropriate control instructions for the vehicle 1304 in this scenario 1300.

As above, a set of vectors 1314 may be determined based on data associated with the environment 1302 in a vicinity of the vehicle 1304. In this example, the set of vectors 1314 may be precomputed for the environment 1302, and provided to a planning system to assist in generating an appropriate set of control instructions for the vehicle 1304. The precomputed set of vectors 13014 indicate that the traffic should flow in a manner as expected if the further vehicle 1310 was not present. Accordingly, the set of vectors 1314 in this case indicate that traffic in this scenario 1302 should flow in one of two, opposite, directions. Sensor data may be generated by a sensor in the environment 1302. The sensor data may indicate the presence of the further vehicle 1310. Based on the sensor data and the set of vectors 1314, it may be determined that the behaviour of the further vehicle 1310 is an anomaly, or that the behaviour is out of distribution based on expected traffic flow through the environment.

A set of instructions may then be generated that cause the vehicle 1304 to remain stationary until the vehicle 1310 has completed the maneuver, rather than follow a current heading of the further vehicle 1310, for example.

It will be appreciated that other examples of anomaly detection are possible using the techniques described herein. For instance, the set of vectors determined according to the techniques of this disclosure may provide an additional anomaly detection capabilities compared with conventional systems that identify agents as acting anomalously if they do not follow the lane geometries or lane directions. In addition to these identifications, agents can be identified as anomalous by comparing their actual behaviour (e.g. heading and/or speed) to their expected behaviour based on the set of vectors. If their actual behaviour differs from the expected behaviour by a threshold amount, that agent may be identified as anomalous. This could be used to identify such agents as slow in lane traffic, speeding vehicles, and emergency vehicles.

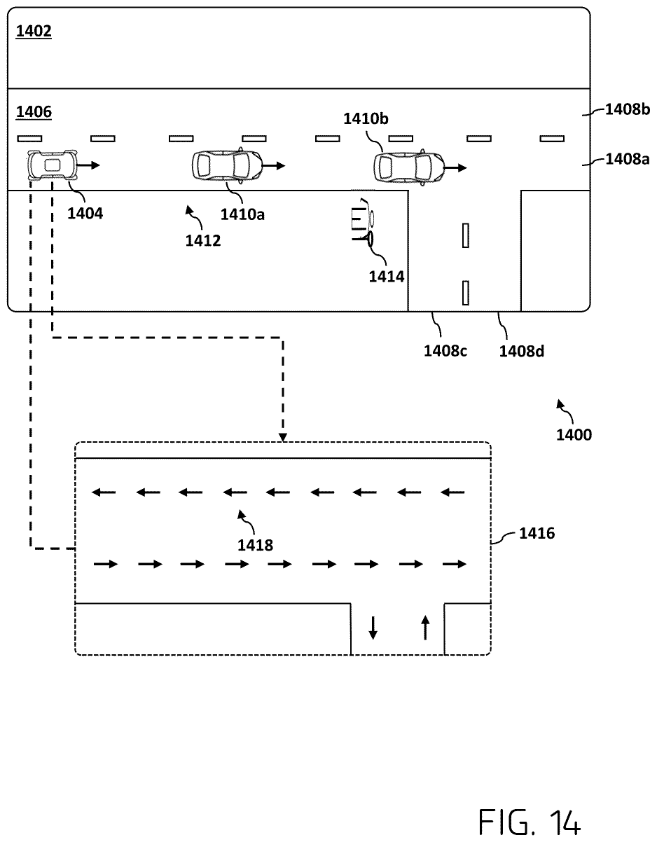

FIG. 14 shows a further example scenario 1400 involving an environment 1402 including a vehicle 1404 traversing a road 1406 having two lanes 1408a, 1408b. The road 1406 includes a junction wherein a further road joins the road 1406, the further road comprising two lanes 1408c, 1408d. The vehicle 1404 may be similar to the vehicles 104, 1104, 1204, 1304 shown in FIGS. 1, 11, 12, 13 respectively. Two further vehicles 1410 a, b are also present in the environment 1402 and travelling at substantially the same speed as the vehicle 1404 (as indicated by the similar lengths of the arrows associated with each vehicle). Together, the vehicle 1404 and further vehicles 1410a, b form traffic 1412.

A person is present in the environment 1402 and holding a stop sign 1414. However, as indicated by the length of the arrows associated with the further vehicles 1410a, b, the speeds of the further vehicles are unchanged in the presence of the stop sign 1414.

To the drivers of the further vehicles, there may be some detail in the environment 1402 to indicate that the stop sign does not need to be adhered to. For instance, the person holding the stop sign may have no authority to do so and may be holding the stop sign dressed in a clown's outfit. Alternatively, the stop sign may be directed towards at least one of the lanes 1408c, d of the further road rather than either of the lanes 1408a, b of the road 1406. Without this additional contextual information, a vehicle control system configured to control the vehicle 1404 may cause the vehicle 1404 to come to a stop.

As above then, a set of vectors 1416 may be determined based on data associated with the environment 1402 in a vicinity of the vehicle 1404. The data associated with the environment 1402 (indicating, for example, speed of other vehicles, road layout, historical traffic flow patterns etc.), apart from the presence of the stop sign 1414, indicate that the traffic should flow in a manner as expected if the stop sign 1414 was not present. Accordingly, the set of vectors 1416 in this case indicate that traffic in this scenario 1402 should flow in one of two, opposite, directions.

A set of instructions may then be generated that cause the vehicle 1404 to continue according to its current trajectory, thereby ignoring the rogue stop sign 1414.

Though not illustrated in a figure, it is understood that there are many other scenarios in which the techniques described herein may be of use. For instance, a jaywalker present in an environment may have an adverse effect on control instructions generated by a vehicle control system since the presence of a person at that location may be unexpected. A set of vectors determined according to the present disclosure may assist the vehicle control system in generating a more appropriate set of control instructions. For instance, the traffic flow represented by the set of vectors may indicate that there is no deviation from the expected traffic flow in that scenario. The vehicle may therefore remain stationary until the jaywalker has exited the road.

In another example, another vehicle may be in a lane that is not appropriate for a current speed of that other vehicle. For example, the other vehicle is slow-in-lane. In this scenario, a set of vectors determined according to the present disclosure may indicate that the traffic flow speed at the position of the other vehicle is faster than the actual speed of that other vehicle. A set of instructions may be generated that safely take the vehicle around the other vehicle.

In yet another example, a set of vectors determined according to the present disclosure may be used in a gridlock scenario. In this case, no other vehicle in an environment may be in motion possibly making it difficult for a vehicle control system to generate an appropriate set of set of control instructions to operate the vehicle. For instance, when a gap in a first flow of traffic in which the vehicle currently is opens up, the vehicle control system may cause the vehicle to enter the gap thereby aiming to maintain a distance between the vehicle and a vehicle in front. However, the location of this gap may be associated with a second flow of traffic moving in a different direction, and so moving the vehicle into the gap may exasperate the gridlock scenario by blocking the second flow of traffic. A determined set of vectors may be generated that are indicative of a total traffic flow in the environment, and so the set of vectors may indicate that the gap in front of the vehicle is associated with both the first and second flows of traffic. Using the set of vectors, the vehicle control system may identify that it should not come to a stop where the first and second traffic flows intersect to avoid blocking vehicles in the second flow of traffic. Such insight may not be possible without the additional contextual information provided by the set of vectors.

In a further example, a set of vectors may be determined according to the present disclosure may be used in a merge scenario, whereby two lanes of unidirectional traffic merge into a single lane. It may be difficult for a conventional vehicle control system to generate an appropriate set of set of control instructions to operate the vehicle because the scenario may be interpreted as vehicles illegally entering the vehicle's currently occupied lane. In this case, the set of vectors may provide an indication of the merge, with the set of vectors being similar to vectors of a vector field associated with fluid flowing through a Y connector. This additional contextual information may allow for the vehicle control system to generate appropriate control instructions for the vehicle that, rather than cause the vehicle to come to a stop to allow vehicles in the other lane to proceed, cause the vehicle to enter a gap between vehicles in the other lane in which to proceed.

FIG. 15 illustrates a block diagram of an example system 1500 that implements the techniques discussed herein. FIG. 15 may represent vehicle 104 and the described computing system 118 of FIG. 1 and/or any of the vehicles 1104, 1204, 1304, 1404 of FIGS. 11-14. In some instances, the example system 1500 may include a vehicle 1502. In some instances, the vehicle 1502 may be an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. However, in other examples, the vehicle 1502 may be a fully or partially autonomous vehicle having any other level or classification. Moreover, in some instances, the techniques described herein may be usable by non-autonomous vehicles as well.

The vehicle 1502 may include a vehicle computing device(s) 1504, sensor(s) 1506, emitter(s) 1508, network interface(s) 1510, and/or drive system(s) 1512. The system 1500 may additionally or alternatively comprise computing device(s) 1522. In some instances, the sensor(s) 1506 may include lidar sensors, radar sensors, ultrasonic transducers, sonar sensors, location sensors (e.g., global positioning system (GPS), compass, etc.), inertial sensors (e.g., inertial measurement units (IMUs), accelerometers, magnetometers, gyroscopes, etc.), image sensors (e.g., red-green-blue (RGB), infrared (IR), intensity, depth, time of flight cameras, etc.), microphones, wheel encoders, environment sensors (e.g., thermometer, hygrometer, light sensors, pressure sensors, etc.), etc. The sensor(s) 1506 may include multiple instances of each of these or other types of sensors. For instance, the radar sensors may include individual radar sensors located at the corners, front, back, sides, and/or top of the vehicle 1502. As another example, the cameras may include multiple cameras disposed at various locations about the exterior and/or interior of the vehicle 1502. The sensor(s) 1506 may provide input to the vehicle computing device(s) 1504 and/or to computing device(s) 232.

The vehicle 1502 may also include emitter(s) 1508 for emitting light and/or sound, as described above. The emitter(s) 1508 may include interior audio and visual emitter(s) to communicate with passengers of the vehicle 1502. Interior emitter(s) may include speakers, lights, signs, display screens, touch screens, haptic emitter(s) (e.g., vibration and/or force feedback), mechanical actuators (e.g., seatbelt tensioners, seat positioners, headrest positioners, etc.), and the like. The emitter(s) 1508 may also include exterior emitter(s). Exterior emitter(s) may include lights to signal a direction of travel or other indicator of vehicle action (e.g., indicator lights, signs, light arrays, etc.), and one or more audio emitter(s) (e.g., speakers, speaker arrays, horns, etc.) to audibly communicate with pedestrians or other nearby vehicles, one or more of which comprising acoustic beam steering technology.

The vehicle 1502 may also include network interface(s) 1510 that enable communication between the vehicle 1502 and one or more other local or remote computing device(s). The network interface(s) 1510 may facilitate communication with other local computing device(s) on the vehicle 1502 and/or the drive component(s) 1512. The network interface(s) 1510 may additionally or alternatively allow the vehicle to communicate with other nearby computing device(s) (e.g., other nearby vehicles, road signals, etc.). The network interface(s) 1510 may additionally or alternatively enable the vehicle 1502 to communicate with computing device(s) 232 over a network 238. In some examples, computing device(s) 232 may comprise one or more nodes of a distributed computing system (e.g., a cloud computing architecture).

The vehicle 1502 may include one or more drive components 1512. In some instances, the vehicle 1502 may have a single drive component 1512. In some instances, the drive component(s) 1512 may include one or more sensors to detect conditions of the drive component(s) 1512 and/or the surroundings of the vehicle 1502. By way of example and not limitation, the sensor(s) of the drive component(s) 1512 may include one or more wheel encoders (e.g., rotary encoders) to sense rotation of the wheels of the drive components, inertial sensors (e.g., inertial measurement units, accelerometers, gyroscopes, magnetometers, etc.) to measure orientation and acceleration of the drive component, cameras or other image sensors, ultrasonic sensors to acoustically detect objects in the surroundings of the drive component, lidar sensors, radar sensors, etc. Some sensors, such as the wheel encoders may be unique to the drive component(s) 1512. In some cases, the sensor(s) on the drive component(s) 1512 may overlap or supplement corresponding systems of the vehicle 1502 (e.g., sensor(s) 1506).

The drive component(s) 1512 may include many of the vehicle systems, including a high voltage battery, a motor to propel the vehicle, an inverter to convert direct current from the battery into alternating current for use by other vehicle systems, a steering system including a steering motor and steering rack (which may be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.). Additionally, the drive component(s) 1512 may include a drive component controller which may receive and pre-process data from the sensor(s) and to control operation of the various vehicle systems. In some instances, the drive component controller may include one or more processors and memory communicatively coupled with the one or more processors. The memory may store one or more components to perform various functionalities of the drive component(s) 1512. Furthermore, the drive component(s) 1512 may also include one or more communication connection(s) that enable communication by the respective drive component with one or more other local or remote computing device(s).

The vehicle computing device(s) 1504 may include processor(s) 1514 and memory 1516 communicatively coupled with the one or more processors 1514. Computing device(s) 1532 may also include processor(s) 1534, and/or memory 1536. The processor(s) 1514 and/or 1534 may be any suitable processor capable of executing instructions to process data and perform operations as described herein. By way of example and not limitation, the processor(s) 1514 and/or 1534 may comprise one or more central processing units (CPUs), graphics processing units (GPUs), integrated circuits (e.g., application-specific integrated circuits (ASICs)), gate arrays (e.g., field-programmable gate arrays (FPGAs)), and/or any other device or portion of a device that processes electronic data to transform that electronic data into other electronic data that may be stored in registers and/or memory.

Memory 1516 and/or 1536 may be examples of non-transitory computer-readable media. The memory 1516 and/or 1536 may store an operating system and one or more software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), non-volatile/Flash-type memory, or any other type of memory capable of storing information. The architectures, systems, and individual elements described herein may include many other logical, programmatic, and physical components, of which those shown in the accompanying figures are merely examples that are related to the discussion herein.

In some instances, the memory 1516 and/or memory 1536 may store a perception component 1518, localization component 15150, planning component 1522, map(s) 1524, driving log data 1526, prediction component 1528, and/or system controller(s) 1530-zero or more portions of any of which may be hardware, such as GPU(s), CPU(s), and/or other processing units.

The perception component 1518 may detect object(s) in in an environment surrounding the vehicle 1502 (e.g., identify that an object exists), classify the object(s) (e.g., determine an object type associated with a detected object), segment sensor data and/or other representations of the environment (e.g., identify a portion of the sensor data and/or representation of the environment as being associated with a detected object and/or an object type), determine characteristics associated with an object (e.g., a track identifying current, predicted, and/or previous position, heading, velocity, and/or acceleration associated with an object), and/or the like. Data determined by the perception component 1518 is referred to as perception data. The perception component 1518 may be configured to associate a bounding region (or other indication) with an identified object. The perception component 1518 may be configured to associate a confidence score associated with a classification of the identified object with an identified object. In some examples, objects, when rendered via a display, can be colored based on their perceived class. The object classifications determined by the perception component 1518 may distinguish between different object types such as, for example, a passenger vehicle, a pedestrian, a bicyclist, motorist, a delivery truck, a semi-truck, road signage, and/or the like.

In at least one example, the localization component 15150 may include hardware and/or software to receive data from the sensor(s) 1506 to determine a position, velocity, and/or orientation of the vehicle 1502 (e.g., one or more of an x-, y-, z-position, roll, pitch, or yaw). For example, the localization component 1520 may include and/or request/receive map(s) 1524 of an environment and can continuously determine a location, velocity, and/or orientation of the autonomous vehicle 1502 within the map(s) 1524. In some instances, the localization component 1520 may utilize SLAM (simultaneous localization and mapping), CLAMS (calibration, localization and mapping, simultaneously), relative SLAM, bundle adjustment, non-linear least squares optimization, and/or the like to receive image data, lidar data, radar data, IMU data, GPS data, wheel encoder data, and the like to accurately determine a location, pose, and/or velocity of the autonomous vehicle. In some instances, the localization component 1520 may provide data to various components of the vehicle 1502 to determine an initial position of an autonomous vehicle for generating a trajectory and/or for generating map data, as discussed herein. In some examples, localization component 1520 may provide, to the perception component 1518, a location and/or orientation of the vehicle 1502 relative to the environment and/or sensor data associated therewith.

The planning component 1522 may receive a location and/or orientation of the vehicle 1502 from the localization component 1520 and/or perception data from the perception component 1518 and may determine instructions for controlling operation of the vehicle 1502 based at least in part on any of this data. In some examples, determining the instructions may comprise determining the instructions based at least in part on a format associated with a system with which the instructions are associated (e.g., first instructions for controlling motion of the autonomous vehicle may be formatted in a first format of messages and/or signals (e.g., analog, digital, pneumatic, kinematic) that the system controller(s) 1530 and/or drive component(s) 1512 may parse/cause to be carried out, second instructions for the emitter(s) 1508 may be formatted according to a second format associated therewith).

The driving log data 1526 may comprise sensor data, perception data, and/or scenario labels collected/determined by the vehicle 1502 (e.g., by the perception component 1518), as well as any other message generated and or sent by the vehicle 1502 during operation including, but not limited to, control messages, error messages, etc. In some examples, the vehicle 1502 may transmit the driving log data 1526 to the computing device(s) 1532.

The prediction component 1528 may generate one or more probability maps representing prediction probabilities of possible locations of one or more objects in an environment. For example, the prediction component 1528 may generate one or more probability maps for vehicles, pedestrians, animals, and the like within a threshold distance from the vehicle 1502. In some examples, the prediction component 1528 may measure a track of an object and generate a discretized prediction probability map, a heat map, a probability distribution, a discretized probability distribution, and/or a trajectory for the object based on observed and predicted behavior. In some examples, the one or more probability maps may represent an intent of the one or more objects in the environment. In some examples, the planner component 1522 may be communicatively coupled to the prediction component 1528 to generate predicted trajectories of objects in an environment. For example, the prediction component 1528 may generate one or more predicted trajectories for objects within a threshold distance from the vehicle 1502. In some examples, the prediction component 1528 may measure a trace of an object and generate a trajectory for the object based on observed and predicted behavior. Although prediction component 1528 is shown on a vehicle 1502 in this example, the prediction component 1528 may also be provided elsewhere, such as in a remote computing device. In some examples, a prediction component may be provided at both a vehicle and a remote computing device. These components may be configured to operate according to the same or a similar algorithm.

The memory 1516 and/or 1536 may additionally or alternatively store a mapping system, a planning system, a ride management system, etc. Although perception component 1518 and/or planning component 1522 are illustrated as being stored in memory 1516, perception component 1518 and/or planning component 1522 may include processor-executable instructions, machine-learned model(s) (e.g., a neural network), and/or hardware.

As described herein, the localization component 1520, the perception component 1518, the planning component 1522, and/or other components of the system 1500 may comprise one or more ML models. For example, the localization component 1520, the perception component 1518, and/or the planning component 1522 may each comprise different ML model pipelines. In some examples, an ML model may comprise a neural network. An exemplary neural network is a biologically inspired algorithm which passes input data through a series of connected layers to produce an output. Each layer in a neural network can also comprise another neural network or can comprise any number of layers (whether convolutional or not). As can be understood in the context of this disclosure, a neural network can utilize machine-learning, which can refer to a broad class of such algorithms in which an output is generated based on learned parameters.

Although discussed in the context of neural networks, any type of machine-learning can be used consistent with this disclosure. For example, machine-learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3 ), Chi-squared automatic interaction detection (CHAD)), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet-50, ResNet-101, VGG, DenseNet, PointNet, and the like. In some examples, the ML model discussed herein may comprise PointPillars, SECOND, top-down feature layers (e.g., see U.S. patent application Ser. No. 15/963,1533, which is incorporated in its entirety herein), and/or VoxelNet. Architecture latency optimizations may include MobilenetV2, Shufflenet, Channelnet, Peleenet, and/or the like. The ML model may comprise a residual block such as Pixor, in some examples.

Memory 1516 may additionally or alternatively store one or more system controller(s) 1530, which may be configured to control steering, propulsion, braking, safety, emitters, communication, and other systems of the vehicle 1502. These system controller(s) 1530 may communicate with and/or control corresponding systems of the drive component(s) 1512 and/or other components of the vehicle 1502.

It should be noted that while FIG. 15 is illustrated as a distributed system, in alternative examples, components of the vehicle 1502 may be associated with the computing device(s) 1532 and/or components of the computing device(s) 1532 may be associated with the vehicle 1502. That is, the vehicle 1502 may perform one or more of the functions associated with the computing device(s) 1532, and vice versa.

### EXAMPLE CLAUSES

A. A system comprising: one or more processors; and one or more non-transitory computer-readable media storing computer-executable instructions that, when executed, cause the system to perform operations comprising: receiving data indicating information about an environment in a vicinity of an autonomous vehicle, wherein the environment comprises a movement of traffic; determining, based at least in part on the data and via a machine learning model, a first set of vectors, wherein vectors in the first set of vectors are associated with respective positions in the vicinity of the autonomous vehicle and have directions indicative of a direction of the movement of traffic at the respective positions and magnitudes indicative of a speed of the movement of traffic at the respective positions; and controlling the autonomous vehicle based at least in part on the first set of vectors, wherein the machine learning model is trained by: receiving training data comprising: scene data representing a scene wherein an example movement of traffic; and an expected set of vectors, wherein vectors in the expected set of vectors have directions indicative of a known direction of the example movement of traffic and magnitudes indicative of a known speed associated with the example movement of traffic at respective positions within the scene; inputting the scene data into the machine learning model to generate a second set of vectors; and updating parameters of the machine learning model based on the second set of vectors and the expected set of vectors.
B. The system of clause A, wherein: the known direction of the example movement of traffic is a direction associated with a lane of a road in the scene, and the known speed associated with the example movement of traffic is a speed limit of the road.
C. The system of clause A or clause B, wherein the first set of vectors is precomputed, and the instructions further cause the system to perform operations comprising: receiving the first set of vectors from a remote computing device.
D. The system of any preceding clause, wherein the scene comprises: a road; a vehicle; and a signal that is not being adhered to by the vehicle.
E. A method comprising: receiving data indicating information about an environment in a vicinity of an autonomous vehicle, wherein the environment comprises a movement of traffic; determining, based at least in part on the data and via a machine learning model, a first set of vectors, wherein vectors in the first set of vectors are associated with respective positions in the vicinity of the autonomous vehicle and have directions indicative of a direction of the movement of traffic at the respective positions and magnitudes indicative of a speed of the movement of traffic at the respective positions; and controlling the autonomous vehicle based at least in part on the first set of vectors, wherein the machine learning model is trained by: receiving training data comprising: scene data representing a scene wherein an example movement of traffic; and an expected set of vectors, wherein vectors in the expected set of vectors have directions indicative of a known direction of the example movement of traffic and magnitudes indicative of a known speed associated with the example movement of traffic at respective positions within the scene; inputting the scene data into the machine learning model to generate a second set of vectors; and updating parameters of the machine learning model based on the second set of vectors and the expected set of vectors.
F. The method of clause E, wherein: the known direction of the example movement of traffic is a direction associated with a lane of a road in the scene, and the known speed associated with the example movement of traffic is a speed limit of the road.
G. The method of clause E or clause F, wherein the first set of vectors is precomputed, and the method comprises: receiving the first set of vectors from a remote computing device.
H. The method of any of clauses E to G, wherein the scene comprises: a road; a vehicle; and a signal that is not being adhered to by the vehicle.
I. One or more non-transitory computer-readable media storing instructions that, when executed, cause one or more processors to perform the method of any of clauses E to H.
J. A method comprising: receiving data associated with an environment in a vicinity of a vehicle; determining, based on the data, a set of vectors associated with a vector field that is indicative of a traffic direction in the environment, such that vectors in the set of vectors are indicative of the traffic direction at respective positions in the environment; and generating instructions to control the vehicle based at least in part on the set of vectors.
K. The method of clause J, wherein the vectors have magnitudes indicative of a traffic speed at the respective positions.
L. The method of clause J or clause K, wherein: the data comprises location data indicative of a location of the vehicle, and the set of vectors are predetermined for an area comprising the location.
M. The method of any of clauses J to L, wherein the data is sensor data generated by a sensor associated with the vehicle, and the method comprises: inputting at least a portion of the sensor data into a machine learning model to determine the set of vectors.
N. The method of any of clauses J to M, wherein the instructions to control the vehicle cause the vehicle to change its speed based on a difference between a current speed of the vehicle and a magnitude of a vector in the set of vectors in a planned trajectory of the vehicle.
O. The method of any of clauses J to N, wherein no other vehicles are in motion in the environment.
P. The method of any of clauses J to O, wherein the environment comprises a further vehicle and the data comprises sensor data received from a sensor associated with the vehicle, the method comprising: determining, based on the sensor data, a direction and speed of the further vehicle; updating the set of vectors based on the direction and speed of the further vehicle to generate an updated set of vectors; and generating further instructions to control the vehicle based at least in part on the updated set of vectors.
Q. The method of any of clauses J to P, wherein the set of vectors is a first set of vectors, the vector field is a first vector field that is indicative of a first traffic direction, the first traffic direction being the traffic direction, the method further comprising: determining, based on the data, a second set of vectors that is indicative of a second traffic direction in the environment, such that vectors in the second set of vectors are indicative of a second traffic direction at respective positions in the environment.
R. The method of clause Q, wherein a first vector in the first set of vectors is associated with a same position as a second vector in the second set of vectors.
S. The method of clause Q or clause R, wherein the first set of vectors is associated with road-going vehicles and the second set of vectors is associated with pedestrians.
T. The method of any of clauses J to S, wherein the set of vectors is determined using a machine learning model, the set of vectors is a second set of vectors, the traffic direction is a second traffic direction, and the environment is a second environment, the method comprising: receiving training data representing a first environment comprising traffic; generating a first set of vectors by inputting the training data into the machine learning model, wherein vectors in the first set of vectors represent an estimate of a first traffic direction in the first environment; and training the machine learning model based on the first set of vectors and a third set of vectors, each vector in the third set of vectors representing a known first traffic direction at respective positions in the first environment.
U. The method of any of clauses J to T, wherein the training data comprises map data, the map data indicating: a portion of transportation network; an indication of a lane direction of the portion of transportation network; and a speed limit associated with the portion of transportation network.
V. The method of any of clauses J to U, wherein the data comprises sensor data received from a sensor associated with the vehicle, the method further comprising: detecting, based on the sensor data and the set of vectors, an anomaly in the environment in the vicinity of the vehicle.
W. The method of any of clauses J to V, comprising: determining a first planned trajectory of the vehicle through the environment; and determining, based on the set of vectors, a second planned trajectory of the vehicle through the environment, different from the first planned trajectory, wherein the instructions to control the vehicle are associated with the second planned trajectory.
X. The method of clause W, comprising: receiving sensor data from a sensor associated with the vehicle, wherein the first planned trajectory is determined based at least on part on the sensor data and a predefined traffic rule.
Y. The method of any of clauses J to X, comprising: receiving sensor data from a sensor associated with the vehicle, determining, based on at least the sensor data the set of vectors, a planned trajectory for the vehicle through the environment, wherein the instructions to control the vehicle are associated with the planned trajectory.
Z. A system comprising: one or more processors; and one or more non-transitory computer-readable media storing computer-executable instructions that, when executed, cause the system to perform the method of any of clauses J to Y.
AA. One or more non-transitory computer-readable media storing instructions that, when executed, cause one or more processors to perform the method of any of clauses J to Z.

While the example clauses described above are described with respect to one particular implementation, it should be understood that, in the context of this document, the content of the example clauses can also be implemented via a method, device, system, computer-readable medium, and/or another implementation. Additionally, any of clauses A-AA may be implemented alone or in combination with any other one or more of the clauses A-AA.

### CONCLUSION

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A system comprising:
one or more processors; and
one or more non-transitory computer-readable media storing computer-executable instructions that, when executed, cause the system to perform operations comprising:
receiving data indicating information about an environment in a vicinity of an autonomous vehicle, wherein the environment comprises a movement of traffic;
determining, based at least in part on the data and via a machine learning model, a first set of vectors, wherein vectors in the first set of vectors are associated with respective positions in the vicinity of the autonomous vehicle and have directions indicative of a direction of the movement of traffic at the respective positions and magnitudes indicative of a speed of the movement of traffic at the respective positions; and
controlling the autonomous vehicle based at least in part on the first set of vectors,
wherein the machine learning model is trained by:
receiving training data comprising:
scene data representing a scene wherein an example movement of traffic; and
an expected set of vectors, wherein vectors in the expected set of vectors have directions indicative of a known direction of the example movement of traffic and magnitudes indicative of a known speed associated with the example movement of traffic at respective positions within the scene;
inputting the scene data into the machine learning model to generate a second set of vectors; and
updating parameters of the machine learning model based on the second set of vectors and the expected set of vectors.

2. The system of claim 1, wherein:
the known direction of the example movement of traffic is a direction associated with a lane of a road in the scene, and
the known speed associated with the example movement of traffic is a speed limit of the road.

3. The system of claim 1, wherein the first set of vectors is precomputed, and the instructions cause the system to perform further operations comprising:
receiving the first set of vectors from a remote computing device.

4. The system of claim 1, wherein the scene comprises:
a road;
a vehicle; and
a signal that is not being adhered to by the vehicle.

5. A method comprising:
receiving data associated with an environment in a vicinity of a vehicle;
determining, based on the data, a set of vectors associated with a vector field that is indicative of a traffic direction in the environment, such that vectors in the set of vectors are indicative of the traffic direction at respective positions in the environment; and
generating instructions to control the vehicle based at least in part on the set of vectors.

6. The method of claim 5, wherein the vectors have magnitudes indicative of a traffic speed at the respective positions.

7. The method of claim 5, wherein:
the data comprises location data indicative of a location of the vehicle, and
the set of vectors are predetermined for an area comprising the location.

8. The method of claim 5, wherein the data is sensor data generated by a sensor associated with the vehicle, and the method comprises:
inputting at least a portion of the sensor data into a machine learning model to determine the set of vectors.

9. The method of claim 5, wherein the instructions to control the vehicle cause the vehicle to change its speed based on a difference between a current speed of the vehicle and a magnitude of a vector in the set of vectors in a planned trajectory of the vehicle.

10. The method of claim 5, wherein no other vehicles are in motion in the environment.

11. The method of claim 5, wherein the environment comprises a further vehicle and the data comprises sensor data received from a sensor associated with the vehicle, the method comprising:
determining, based on the sensor data, a direction and speed of the further vehicle;
updating the set of vectors based on the direction and speed of the further vehicle to generate an updated set of vectors; and
generating further instructions to control the vehicle based at least in part on the updated set of vectors.

12. The method of claim 5, wherein the set of vectors is a first set of vectors, the vector field is a first vector field that is indicative of a first traffic direction, the first traffic direction being the traffic direction, the method further comprising:
determining, based on the data, a second set of vectors that is indicative of a second traffic direction in the environment, such that vectors in the second set of vectors are indicative of a second traffic direction at respective positions in the environment.

13. The method of claim 12, wherein a first vector in the first set of vectors is associated with a same position as a second vector in the second set of vectors.

14. The method of claim 5, wherein the set of vectors is determined using a machine learning model, the set of vectors is a second set of vectors, the traffic direction is a second traffic direction, and the environment is a second environment, the method comprising:
receiving training data representing a first environment comprising traffic;
generating a first set of vectors by inputting the training data into the machine learning model, wherein vectors in the first set of vectors represent an estimate of a first traffic direction in the first environment; and
training the machine learning model based on the first set of vectors and a third set of vectors, each vector in the third set of vectors representing a known first traffic direction at respective positions in the first environment.

15. The method of claim 14, wherein the training data comprises map data, the map data indicating:
a portion of transportation network;
an indication of a lane direction of the portion of transportation network; and
a speed limit associated with the portion of transportation network.

16. The method of claim 5, wherein the data comprises sensor data received from a sensor associated with the vehicle, the method further comprising:
detecting, based on the sensor data and the set of vectors, an anomaly in the environment in the vicinity of the vehicle.

17. The method of claim 5, comprising:
determining a first planned trajectory of the vehicle through the environment; and
determining, based on the set of vectors, a second planned trajectory of the vehicle through the environment, different from the first planned trajectory, wherein the instructions to control the vehicle are associated with the second planned trajectory.

18. The method of claim 17, comprising:
receiving sensor data from a sensor associated with the vehicle, wherein the first planned trajectory is determined based at least on part on the sensor data and a predefined traffic rule.

19. The method of claim 5, comprising:
receiving sensor data from a sensor associated with the vehicle,
determining, based on at least the sensor data the set of vectors, a planned trajectory for the vehicle through the environment,
wherein the instructions to control the vehicle are associated with the planned trajectory.

20. One or more non-transitory computer-readable media storing instructions that, when executed, cause one or more processors to perform operations comprising:
receiving data associated with an environment in a vicinity of a vehicle;
determining, based on the data, a set of vectors associated with a vector field that is indicative of a traffic direction in the environment, such that vectors in the set of vectors are indicative of the traffic direction at respective positions in the environment; and
generating instructions to control the vehicle based at least in part on the set of vectors.
